(19) United States
(12) Patent Application Publication
(10) Pub. No.: US 2005/0102363 A1
(43) Pub. Date: May 12, 2005

(54) E-mail transmission control device and program thereof

(75) Inventors: Makoto Yokomura, Neyagawa-shi (JP); Takashi Hayashi, Takatsuki-shi (JP); Takashi Satomura, Kobe-shi (JP); Toshiro Mitamura, Katano-shi (JP); Rika Aizawa, Jyoyo-shi (JP); Masaru Moriwaki, Neyagawa-shi (JP); Soichiro Fujioka, Sakai-shi (JP); Minoru Hirano, Kyoto-shi (JP); Yuichiro Hara, Kyoto-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co. Ltd., Kadoma-shi (JP)

(21) Appl. No.: 10/983,759

(22) Filed: Nov. 9, 2004

(30) Foreign Application Priority Data
Nov. 11, 2003 (JP) 2003-380914

(51) Int. Cl. G06F 15/16

(52) U.S. Cl. 709/206

(57) ABSTRACT

An E-mail transmission control device comprises: a mail information storage unit; a destination information storage unit; an E-mail transmission unit; an error information reception unit for receiving error information; an error information decision unit for deciding whether or not the error information satisfies a predetermined condition; a destination excluding unit for executing the destination indicated by the destination information owned by the error information, from the candidates of the destination, in case the error information decision unit decides the satisfaction of the predetermined condition. The electronic transmission control device further comprises a re-transmission decision unit for deciding whether or not a predetermined condition is satisfied, after the destination excluding unit performed the exclusion. The E-mail transmission unit transmits the E-mail to the excluded destination in case the re-transmission decision unit decides the satisfaction of the predetermined condition.

### FIELD OF THE INVENTION

The present invention relates to an E-mail transmission control device or the like for controlling the transmission of an E-mail.

### BACKGROUND OF THE INVENTION

An E-mail address managing system for deleting such one of registered addresses as becomes unusable automatically from an address note or mailing list is described as the related art in JP-A-2000-259514 (1 page, FIG. 1 and the like).

The E-mail address management system of the related art deletes the erroneous mail address from the address note or mailing list. There arises a problem that the mail address is deleted in case the power is turned OFF for a long term by a trouble of a mail server or the like or for maintenance.

### SUMMARY OF THE INVENTION

According to the invention, there is provided an E-mail transmission control device comprising: a mail information storage unit stored with mail information or information on an E-mail; a destination information storage unit stored with one or more pieces of information or information indicating a destination of the E-mail; an E-mail transmission unit for transmitting an E-mail to the destination indicated by the one or more pieces of destination information; an error information reception unit for receiving information of error on the transmission of the E-mail or error information having destination information; an error information decision unit for deciding whether or not the error information received by the error information reception unit satisfies a predetermined condition; a destination excluding unit for excluding the destination indicated by the destination information owned by the error information, from the candidates of the destination of the E-mail, in case the error information decision unit decides the satisfaction of the predetermined condition; and a re-transmission decision unit for deciding whether or not a predetermined condition is satisfied, after the destination excluding unit performed the exclusion, wherein the E-mail transmission unit transmits the E-mail to the excluded destination in case the re-transmission decision unit decides the satisfaction of the predetermined condition.

According to this configuration, the E-mail can be transmitted again to the destination address which has been excluded from the candidates of the destination because the mail transmission could not be executed in case the power is turned OFF for a long term by the trouble of the mail server or the like or for a maintenance.

### BRIEF DESCRIPTION OF THE DRAWINGS

FIG. 1 is a block diagram showing a configuration of an E-mail transmission control device in one embodiment of the invention;

FIG. 2 is a flow chart showing the operations of the E-mail transmission control device in one embodiment of the invention;

FIG. 3 is a conceptional diagram of the E-mail transmission control device in one embodiment of the invention;

FIG. 4 is a diagram showing a data example of destination information in one embodiment of the invention;

FIG. 5 is a diagram showing a data example of mail information in one embodiment of the invention;

FIG. 6 is a diagram showing a data example of an error information history in one embodiment of the invention;

FIG. 7 is a diagram showing an example of an exclusion deciding condition table in one embodiment of the invention;

FIG. 8 is a diagram showing an example of destination information after excluded in one embodiment of the invention;

FIG. 9 is a diagram showing a data example of destination information after restored in one embodiment of the invention;

FIG. 10 is a block diagram showing a configuration an E-mail transmission control device in one embodiment of the invention;

FIG. 11 is a flow chart showing the operations of the E-mail transmission control device in one embodiment of the invention;

FIG. 12 is a diagram showing a data example of destination information in one embodiment of the invention;

FIG. 13 is a diagram showing an example of untransmitted E-mail information in one embodiment of the invention;

FIG. 14 is a block diagram showing a configuration of an E-mail transmission control device in one embodiment of the invention;

FIG. 15 is a flow chart showing the operations of the E-mail transmission control device in one embodiment of the invention;

FIG. 16 is a diagram showing an example of a transmission propriety mail in one embodiment of the invention;

FIG. 17 is a diagram showing an example of a transmission propriety mail in one embodiment of the invention;

FIG. 18 is a diagram showing an example of the contents of replied data in one embodiment of the invention;

FIG. 19 is a block diagram showing a configuration of an E-mail transmission control device in one embodiment of the invention;

FIG. 20A is a flow chart showing the operations of the E-mail transmission control device in one embodiment of the invention;

FIG. 20B is a flow chart showing the operations of the E-mail transmission control device in one embodiment of the invention;

FIG. 21 is a diagram showing an example of menu information data in one embodiment of the invention;

FIG. 22 is a diagram showing an example of data of an E-mail in one embodiment of the invention;

FIG. 23 is a diagram showing a display example of menu information displayed in the display screen of a user in one embodiment of the invention;

FIG. 24 is a diagram showing a display example of a confirmation screen in one embodiment of the invention;

FIG. 25 is a diagram showing a display example of a registration finish screen in one embodiment of the invention;

FIG. 26 is a diagram showing a data example of menu item selecting information in one embodiment of the invention;

FIG. 27 is a block diagram showing a configuration of an E-mail transmission control device in one embodiment of the invention;

FIG. 28 is a flow chart showing the operations of the E-mail transmission control device in one embodiment of the invention;

FIG. 29 is a diagram showing a data example of E-mail information in one embodiment of the invention;

FIG. 30 is a diagram showing an example of an E-mail in one embodiment of the invention;

FIG. 31 is a diagram showing an example of E-mail information transmitted in one embodiment of the invention; and

FIG. 32 is a diagram showing an example of a display screen of E-mail information in one embodiment of the invention.

### DETAILED DESCRIPTION OF THE INVENTION

(Preferred Embodiment)

Embodiments of the invention will be described in detail with reference to the accompanying drawings. In these embodiments, the configuration components and the flow chart steps, which are designated by identical reference numerals, perform the common functions. Therefore, the description of those components and steps once described will be omitted, as the case may be.

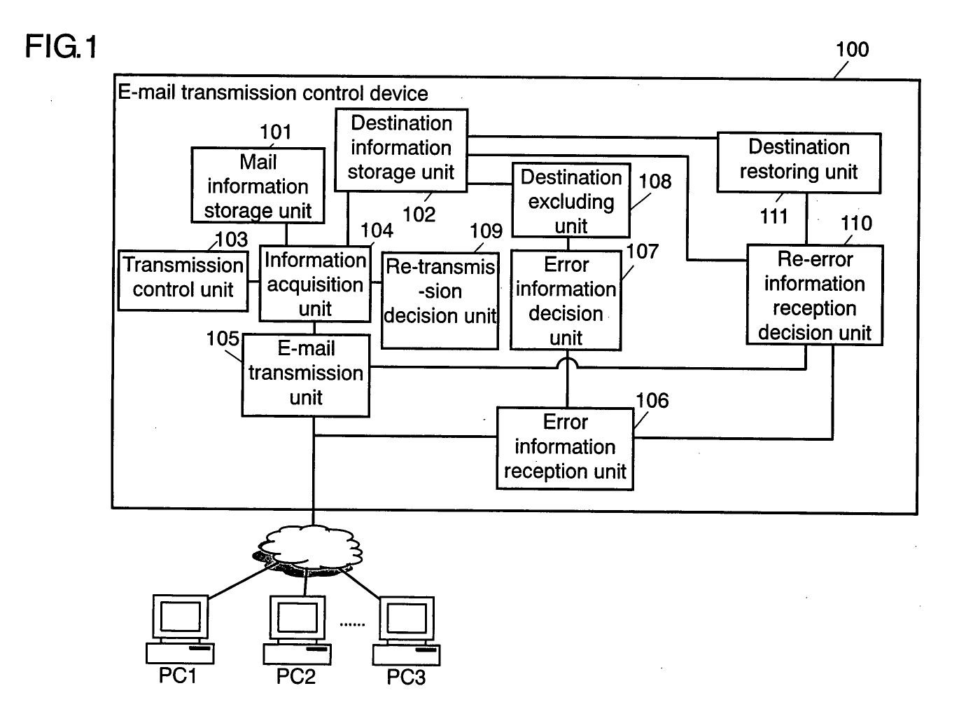

FIG. 1 is a block diagram showing a configuration of E-mail transmission control device 100 in this embodiment. E-mail transmission control device 100 is configured to include mail information storage unit 101, destination information storage unit 102, transmission control unit 103, information acquisition unit 104, E-mail transmission unit 105, error information reception unit 106, error information decision unit 107, destination excluding unit 108, re-transmission decision unit 109, re-error information reception decision unit 110, and destination restoring unit 111.

E-mail transmission control device 100 is provided (although not shown) with hardware resources owned by the ordinary electronic computer, such as a CPU, a main memory or a record medium (e.g., a ROM or an EPROM), and a peripheral device (e.g., an input device such as a keyboard or a mouse, and an output device such as display). This provision is like that of another embodiment.

Mail information storage unit 101 is stored with the mail information such as the information on the E-mail. Here, “E-mail” means the so-called contents or general information, and contains files of any format and structure. The data type of the “E-mail” may also be any such as voices, images or animations. The “mailinformation” is exemplified by an E-mail, an E-mail identifier for identifying the E-mail or a pointer indicating the place where the E-mail is stored. The E-mail may be stored in advance in mail information storage unit 101 or may be transmitted from and stored in an external device or the like. The E-mail may also be directly inputted from input accepting means (e.g., an input device). Mail information storage unit 101 is properly exemplified by a nonvolatile record medium but also by a volatile record medium. In case the E-mail is directly inputted from the input accepting means (e.g., the input device), the word “stored” means a concept containing a temporary storage in a main memory or the like.

Destination information storage unit 102 is stored with at least one piece of destination information or the information indicating the destination of the E-mail. The “destination information” is exemplified by a mail address. Destination information storage unit 102 is properly exemplified by nonvolatile record medium but may be exemplified by volatile record medium.

Transmission control unit 103 instructs the transmission start for E-mail transmission unit 105 to transmit the E-mail. The “instruction of transmission start” is exemplified by an instruction to transmit at a predetermined time or an instruction to transmit when the E-mail is received from the external device. Transmission control unit 103 can be normally realized by an MPU, memory or the like. The processing procedure for “instructing the transmission start” is usually realized by the software, which is stored in the record medium such as the ROM. However, the processing procedure may also be realized by hardware (or a dedicated circuit). Transmission configuration unit 103 may be present or absent. In the absence of transmission control unit 103, E-mail transmission unit 105 starts the transmission, for example, when a predetermined period is elapsed. In order to start the transmission, E-mail transmission unit 105 instructs information acquisition unit 104 to acquire the E-mail and the destination information.

Information acquisition unit 104 acquires the E-mail stored in mail information storage unit 101. Information acquisition unit 104 also acquires the destination information stored in destination information storage unit 102. Information acquisition unit 104 can usually be realized by an MPU, a memory or the like. The processing procedure for the “acquisition” is usually realized by the software, which is recorded in the record medium such as a ROM. The procedure may also be realized by hardware (or a dedicated circuit).

E-mail transmission unit 105 transmits the E-mail to the destination indicated by one or more piece of destination information. E-mail transmission unit 105 transmits the E-mail to the excluded transmission in case re-transmission decision unit 109 decides that a predetermined condition is satisfied. E-mail transmission unit 105 is realized to include a network card, its driver software and so on.

Error information reception unit 106 receives the error information. The “error information” is the information of an error in the transmission of the E-mail, and has the destination information. Error information reception unit 106 is realized, for example, by including a network card, its driver software and so on.

Error information decision unit 107 decides whether or not the error information received by error information reception unit 106 satisfies predetermined conditions. The “predetermined conditions” are exemplified by that the accumulated reception times of the error information is a predetermined number or more, that the error information has been continuously received predetermined times or more, and so on. Error information decision unit 107 can be usually realized by an MPU, a memory or the like. The procedure for the “decision” is usually realized by software, which is recorded in a record medium such as a ROM. However, the deciding procedure may also be realized by hardware (or a dedicated circuit).

Destination excluding unit 108 executes such an excluding operation, in case error information decision unit 107 decides the satisfaction of the predetermined conditions, as to exclude the destination indicated by the destination information owned by that error information, from the candidates of the destination of the E-mail. The “excluding operation” is exemplified by that a transmission inhibition flag is raised at the data of the destination information, that information specifying the excluded destination is added to the data of the destination excluding information other than the data of the destination information, and so on. Destination excluding unit 108 can be usually realized by an MPU, a memory or the like. The procedure for “excluding” is usually realized by the software, which is stored in a record medium such as a ROM. However, the excluding procedure may also be realized by a hardware (or a dedicated circuit).

Re-transmission decision unit 109 decides, after destination excluding unit 108 executed the excluding operation, whether or not the predetermined condition is satisfied. The “predetermined condition” is that a predetermined period has elapsed after destination excluding unit 108 executed the excluding operation. Alternatively, the “predetermined condition” is that E-mail transmission unit 105 has transmitted E-mails by a predetermined number of times after destination excluding unit 108 executed the excluding operation. The “predetermined number of times” is exemplified by the number of times of having transmitted one E-mail, the number of times of having transmitted different E-mails, the number of times of having transmitted different E-mails independently of the destination, the same number of times as that of all E-mails stored for a predetermined arbitrary time period (as conditioned on that all the stored E-mails have been transmitted), and so on. Re-transmission decision unit 109 can be usually realized by an MPU or a memory. The procedure for the “decision” is usually realized by a software, which is recorded in a record medium such as a ROM. The decision procedure may also be realized by a hardware (or a dedicated circuit).

After destination excluding unit 108 executed the excluding operation, re-transmission decision unit 109 decides that the predetermined conditions are satisfied, so that E-mail transmission unit 105 transmits the E-mail to that excluded transmission. In this case, re-error information reception decision unit 110 decides whether or not the error information (as will be called the “re-error information”) has been received from the excluded transmission. Re-error information reception decision unit 110 can be usually realized by an MPU, a memory or the like. The “deciding” procedure is usually realized by software, which is recorded in a record medium such as a ROM. The deciding procedure may also be realized by hardware (or a dedicated circuit).

Destination restoring unit 111 executes, in case re-error information reception decision unit 110 decides that the error information has not been received, the operation to change the destination not having transmitted that error information, into the destination of an ordinary E-mail. This “operation” is exemplified by that the flag of the transmission inhibition is excluded from the data of the destination information, that the record indicating the corresponding destination is deleted from the destination excluding information data, and so on. Designation restoring unit 111 can be usually realized by an MPU, a memory or the like. The procedure for the “operation” is usually realized by a software, which is recorded in a record medium such as a ROM. The operation procedure may also be realized by hardware (or a dedicated circuit).

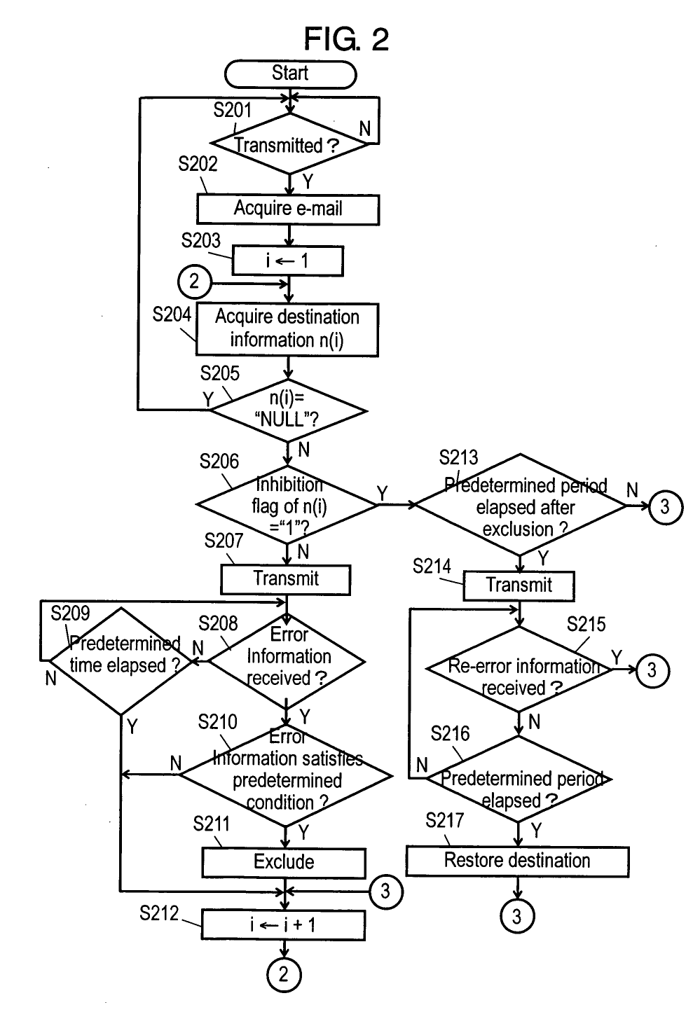

The operations of E-mail transmission control device 100 in this embodiment will be described in the following with reference to the flow chart of FIG. 2.

(At Step S201): Transmission control unit 103 decides whether or not an instruction to start the transmission of E-mail is to be given. The routine advances to Step S202, in case transmission control unit 103 gives the instruction to start the transmission, but otherwise returns to Step S201.

(At Step S202): Information acquisition unit 104 acquires the E-mail from mail information storage unit 101 in response to the transmission starting instruction of Step S201.

(At Step S203): Information acquisition unit 104 initializes “i” to “1”.

(At Step S204): Information acquisition unit 104 acquires i-th destination information n(i) from destination information storage unit 102.

(At Step S205): Information acquisition unit 104 decides whether or not destination information n(i) is “NULL”. The routine returns to Step S201, in case destination information n(i) is “NULL”, but otherwise to Step S206. In case destination information n(i) is at “NULL”, this means the absence of destination information n(i).

(At Step S206): Information acquisition unit 104 decides whether or not the inhibition flag of destination information n(i) is at “1”. The routine advances to Step S213, in case the inhibition flag is at “1”, but otherwise to Step S207.

(At Step S207): E-mail transmission unit 105 transmits the E-mail acquired at Step S202, to the destination of destination information n(i).

(At Step S208): Error information reception unit 106 decides whether or not the error information on the E-mail transmitted at Step S207 has been received. The routine advances to Step S210, in case the error information has been received, but otherwise to Step S209.

(At Step S209): Error information reception unit 106 decides whether or not a predetermined period has elapsed from the time of transmission of Step S207. The routine advances to Step S212, in case the predetermined period has elapsed, but otherwise returns to Step S208. Here, the “predetermined period” is an arbitrary time period.

(At Step S210): Error information decision unit 107 decides whether or not the error information received at Step S208 satisfies the predetermined condition. The routine advances to Step S211, in case the predetermined condition is satisfied, but otherwise to Step S212.

(At Step S211): Transmission excluding unit 108 executes an excluding operation to exclude destination information n(i) from the candidates of the destination. In the present flow chart, the excluding operation is to set the inhibition flag to “1”.

(At Step S212): Information acquisition unit 104 increments the “i” by 1. The routine returns to Step S204.

(At Step S213): Re-transmission decision unit 109 decides whether or not a predetermined period has elapsed after destination information n(i) was excluded. The routine advances to Step S214, in case the predetermined time has elapsed, but otherwise to Step S212.

(At Step S214): E-mail transmission unit 105 transmits the E-mail acquired at Step S202, to the destination of destination information n(i).

(At Step S215): Re-error information reception decision unit 110 decides whether or not the error information on the E-mail received at Step S214 has been received by error information reception unit 106. The routine advances to Step S212, in case the error information has been received, but otherwise to Step S216.

(At Step S216): Re-error information reception decision unit 110 decides whether or not a predetermined period has elapsed from the time when the E-mail was transmitted at Step S214. The routine advances to Step S217, in case the predetermined period has elapsed, but otherwise returns to Step S215.

(At Step S217): Destination restoring unit 111 sets the inhibition flag of destination information n(i) to “0”. The routine returns to Step S212.

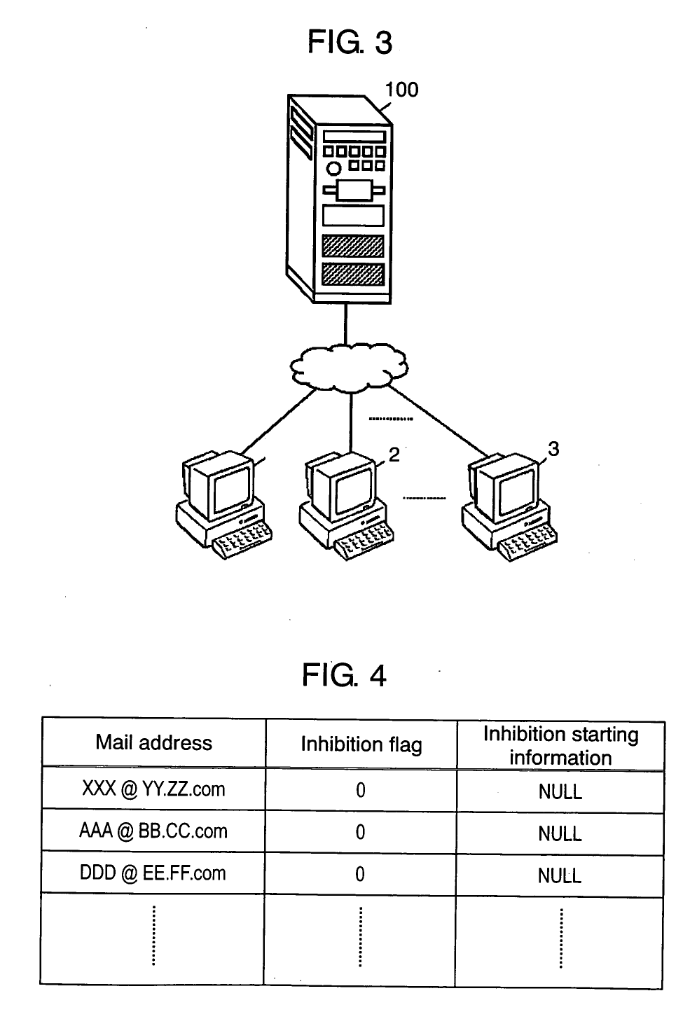

Here will be described the specific operations of E-mail transmission control device 100 in this embodiment. FIG. 3 is a diagram showing the concept of E-mail transmission control device 100. In FIG. 3, E-mail transmission control device 100 is connected through the Internet with user terminals 1, 2 and 3 (including the not-shown user terminal).

FIG. 4 is a diagram showing data examples of the destination information. In FIG. 4, the destination information includes mail addresses, inhibition flags, and inhibition starting information. Now, all the inhibition flags are at “0”. The case of the inhibition flag at “0” means that the destination is not excluded from the candidates of the destination. On the other hand, the case of the inhibition flag at “1” means that the destination is excluded from the candidates of the destination. The destination information is stored in destination information storage unit 102.

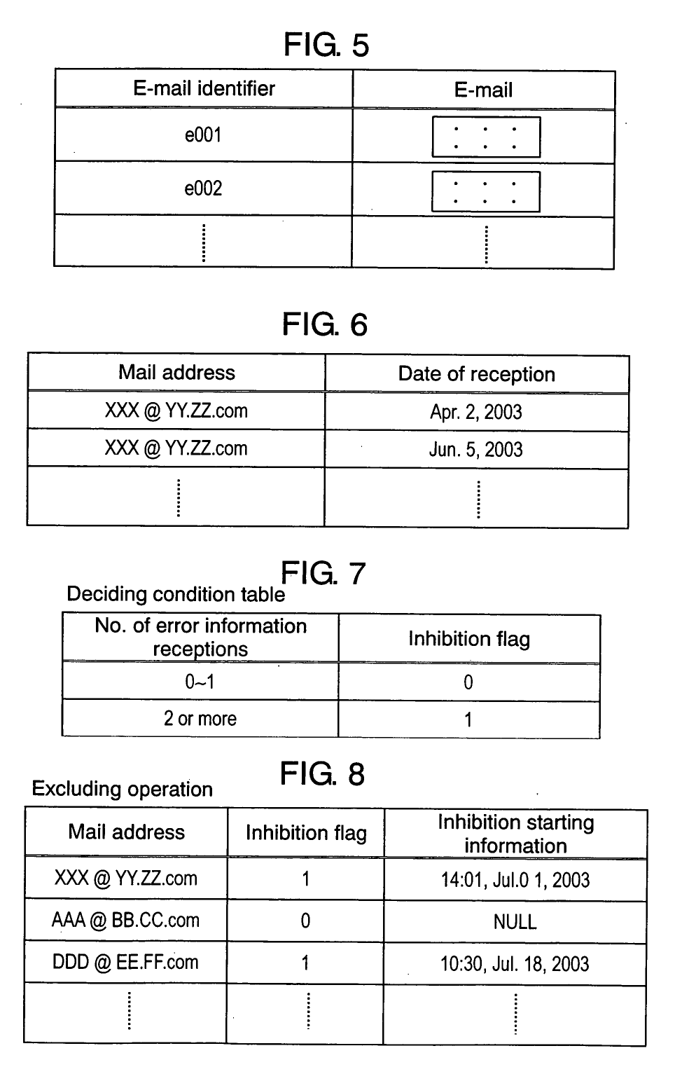

FIG. 5 is a diagram showing data examples of the mail information. In FIG. 5, the mail information contains E-mail identifiers and E-mails. The mail information may contain pointers indicating the places where the E-mails are stored.

Here will be described the case, in which an E-mail is to be transmitted.

In case transmission control unit 103 instructs a transmission start, information acquisition unit 104 acquires the E-mail from mail information storage unit 101. Next, information acquisition unit 104 acquires destination information n(i) sequentially from destination information storage unit 102. In case the inhibition flag of destination information n(i) is at “0”, E-mail transmission unit 105 transmits the E-mail to the destination which is specified with the mail address of destination information n(i). The case, in which the inhibition flag of destination information n(i) is at “1”, will be described hereinafter.

Here will be described the excluding operation for making an extrusion from the candidates of the destination. In case error information reception unit 106 receives error information for the E-mail which has been transmitted by E-mail transmission unit 105 to the destination specified with the mail address of destination information n(i), error information decision unit 107 stores the error information as an error information history in the storage medium such as a buffer. FIG. 6 is a diagram showing data examples of the error information history. This error information history contains the information on the mail addresses and the dates of reception. Error information decision unit 107 decides from the error information history whether or not the mail address of destination information n(i) exists by a predetermined number of times or more. In case it is decided that the mail address exists by the predetermined number of times or more, destination excluding unit 108 changes the inhibition flag of destination information n(i) from “0” to “1”. Destination excluding unit 108 writes the date and hour, on which the inhibition flag is set to “1”, in the inhibition starting information of destination information n(i). The “decision by the predetermined or more times” is based on the exclusion deciding condition table. FIG. 7 shows examples of the exclusion deciding condition table. In FIG. 7, the inhibition flag is set to “0” in case the number of error information receptions is “from 0 to 1”. In case the number of error information receptions is “2 or more”, the inhibition flag is set to “1”. FIG. 8 is a diagram showing examples of the destination information after the excluding operations. In FIG. 8, the mail address “xxx@yy.zz.com” indicates that the inhibition flag is at “1”, and that the inhibition starting information is “14: 01, Jul. 1, 2003”.

Here will be described the case, in which the transmission is made to the destination specified with the excluded mail address. In case the inhibition flag of the destination information n(i) acquired by information acquisition unit 104 is at “1”, re-transmission decision unit 109 decides whether or not a predetermined period has elapsed from the date of inhibition starting information. In case a predetermined period has elapsed, E-mail transmission unit 105 transmits the E-mail to the address of the excluded destination information n(i). The “predetermined period” is an arbitrary period such as a period of one week or one month from the date and hour of the inhibition starting information.

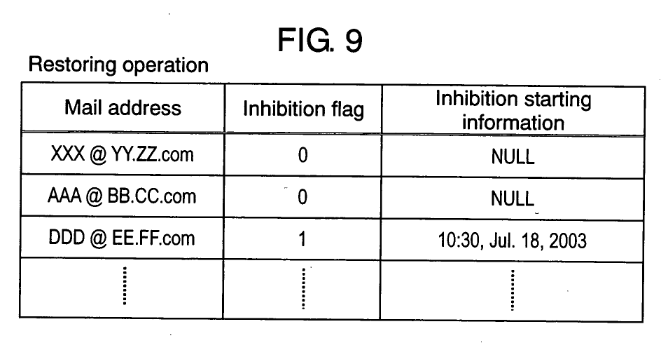

Here will be described an operation to restore the excluded mail address. Re-error information reception decision unit 110 decides whether or not the error information received by error information reception unit 106 is one to the E-mail which has been transmitted to the destination specified with the excluded mail address. In case the error information is one to the E-mail which has been transmitted to the destination specified with the excluded mail address, destination restoring unit 111 sets the inhibition flag of the excluded mail address from “1” to “0”. Destination restoring unit 111 further sets the inhibition starting information of the excluded mail address to “NULL”. Destination restoring unit 111 may add the date and hour, at which the inhibition was released, to the inhibition starting information of the excluded mail address. FIG. 9 is a diagram showing data examples of the destination information after restored. In FIG. 9, the mail address “xxx@yy.zz.com” of the destination information indicates that the inhibition flag is at “0”, and that the inhibition starting information is at “NULL”. It is meant that the contents (as referred to FIG. 8) excluded from the candidates of the destination are changed to the contents which have been restored as the ordinary destination unexcluded. The “ordinary destination” means the destination which is not deleted from the candidates of the destination.

In this embodiment, the E-mail transmission control device transmits the E-mail to not only the destination excluded from the destination candidates but also to the destination unexcluded from the candidates. However, the E-mail transmission control device may transmit the E-mail exclusively to the destination excluded from the candidates. In this case, the E-mail may be a dummy mail. In case the error information on the dummy mail is not received, it is arbitrary to restore the destination which has been excluded from its candidates.

In case the power is OFF for a long time either due to a failure in the mail server or for maintenance, according to this embodiment, the E-mail can be transmitted again to the destination which has been excluded from the candidates because of impossibility of the mail transmission. Moreover, the E-mail can be transmitted to both the excluded and unexcluded destinations so that the load on the mail server can be reduced as compared with the case in which the E-mail is transmitted separately to the excluded destination and the unexcluded destination.

In this embodiment, E-mail transmission control device 100 executes the operation to restore the excluded destination but may not execute that operation. In this case, E-mail transmission control device 100 need not be provided with re-error information reception decision unit 110 and destination restoring unit 111.

The operations of E-mail transmission control device 100 thus far described may be realized by the software, which is installed on the server so that it may be distributed by down-loading it. The software may also be distributed by recording it on a record medium such as a CD-ROM. This distribution likewise applies to all other embodiments. The programs of the case in which the operations in this embodiment are realized by the software are as follows. The program causes the computer to execute: an E-mail transmission step of transmitting an E-mail to the destination indicated by the one or more pieces of destination information; an error information reception step of receiving the information of error on the transmission of the E-mail or the error information having destination information; an error information decision step of deciding whether or not the error information received by the error information reception step satisfies a predetermined condition; a destination excluding step of excluding the destination indicated by the destination information owned by the error information, from the candidates of the destination of the E-mail, in case the error information decision step decides the satisfaction of the predetermined condition; a re-transmission decision step of deciding whether or not a predetermined condition is satisfied, after the destination excluding step performed the exclusion; and an E-mail transmission step of transmitting the E-mail to the excluded destination in case the re-transmission decision step decides the satisfaction of the predetermined condition.

The program causes the computer to further execute: an E-mail transmission step of transmitting an E-mail to the destination indicated by the one or more pieces of destination information; an error information reception step of receiving the information of error on the transmission of the E-mail or the error information having destination information; an error information decision step of deciding whether or not the error information received by the error information reception step satisfies a predetermined condition; a destination excluding step of excluding the destination indicated by the destination information owned by the error information, from the candidates of the destination of the E-mail, in case the error information decision step decides the satisfaction of the predetermined condition; and a transmission step of transmitting the E-mail not only to the excluded destination but also to the unexcluded destination, in case the satisfaction of the predetermined condition is decided at the re-transmission deciding step, after the destination excluding step executed the exclusion.

The program causes the computer to further execute: a re-error information reception decision step of deciding whether or not the error information has been received from the excluded destination, in case the re-transmission decision step has decided the satisfaction of the predetermined condition after the exclusion was executed at the destination excluding step so that the E-mail has been transmitted to the excluded destination; and a destination restoring step of restoring the destination from which the error information has not been transmitted, to the destination of an ordinary E-mail, in case it has been decided at the re-error information reception decision step that the error information was not received.

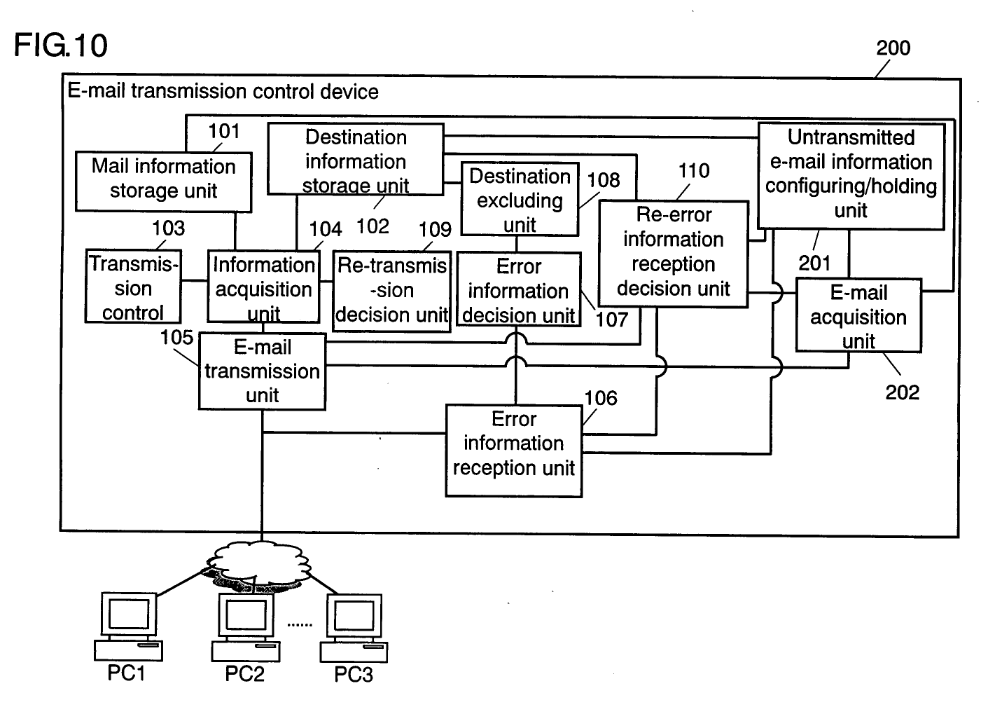

FIG. 10 is a block diagram showing a configuration of another E-mail transmission control device 200 in this embodiment. E-mail transmission control device 200 is configured to include mail information storage unit 101, destination information storage unit 102, transmission control unit 103, information acquisition unit 104, E-mail transmission unit 105, error information reception unit 106, error information decision unit 107, destination excluding unit 108, re-transmission decision unit 109, re-error information reception decision unit 110, untransmitted E-mail information configuring/holding unit 201, and E-mail acquisition unit 202.

Untransmitted E-mail information configuring/holding unit 201 configures and holds the untransmitted E-mail information on the information of the E-mail, which could not be and/or was not transmitted, in a manner to correspond to the destination information. The word “configures” means a suitable updating of the untransmitted E-mail information by adding, deleting or changing it. The word “holds” means a concept of holding of the information in the record medium and contains a temporary holding. The phrase “untransmitted E-mail information” is exemplified by the destination identifier, the E-mail identifier, information on whether or not the E-mail has been transmitted, or the like, as will be hereinafter specified. Untransmitted E-mail information cinfiguring/holding unit 201 is usually realized by an MPU, a memory or the like. The operation procedure for the operations of “configures and holds” is usually realized by software, which is recorded on a record medium such as a ROM, but may be realized by hardware (or a dedicated circuit).

In case re-error information reception decision unit 110 has decided that the error information was not received, E-mail acquisition unit 202 decides the E-mail, that is made to correspond to the destination information indicating the destination from which the error information has not been transmitted, and that could not be and/or was not transmitted, from the untransmitted E-mail information held by untransmitted E-mail information configuring/holding unit 201, and acquires it from the E-mail held by mail information storage unit 101. E-mail acquisition unit 202 can be usually realized by an MPU, a memory or the like. The operation procedure to “acquire” is usually realized by software, which is recorded in a record medium such as a ROM, but may be realized by a hardware (or a dedicated circuit).

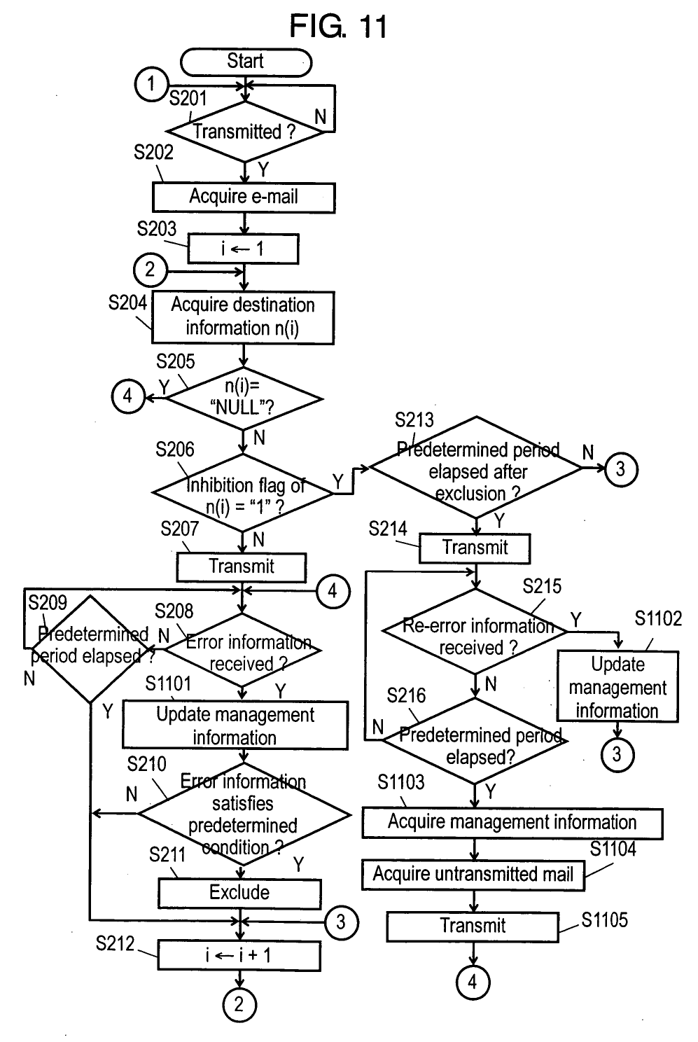

The operations of E-mail transmission control device 200 in this embodiment will be described with reference to the flow chart of FIG. 11. The steps and so on of the flow chart using the common reference numerals perform the common functions in the other embodiment, and their description is omitted.

(At Step S1101): Untransmitted E-mail information configuring/holding unit 201 updates the untransmitted E-mail information because it is decided at Step S208 that the error information has been received. A specific example of the untransmitted E-mail information will be described hereinafter (as referred to FIG. 13). The routine advances to Step S210.

(At Step S1102): Untransmitted E-mail information configuring/holding unit 201 updates the untransmitted E-mail information because the re-error information has been received at Step S215, as will be detailed in the following. The routine advances to Step S212.

(At Step S1103): E-mail acquisition unit 202 acquires the untransmitted E-mail information from untransmitted E-mail information configuring/holding unit 201 because it is decided at Step S215 and at Step S216 that the re-error information has not been received for the predetermined period, as will be detailed hereinafter.

(At Step S1104): Deciding from the untransmitted E-mail information acquired at Step S1103, E-mail acquisition unit 202 acquires the untransmitted mail from mail information storage unit 101.

(At Step S1105): E-mail transmission unit 105 transmits the untransmitted E-mail acquired at Step S1104, to the destination which is specified with the mail address of destination information n(i). The routine returns to Step S208.

Here will be described the specific operations of E-mail transmission control device 200 in this embodiment. Conceptional diagram of E-mail transmission control device 200 is similar to that of FIG. 3, and its description is omitted.

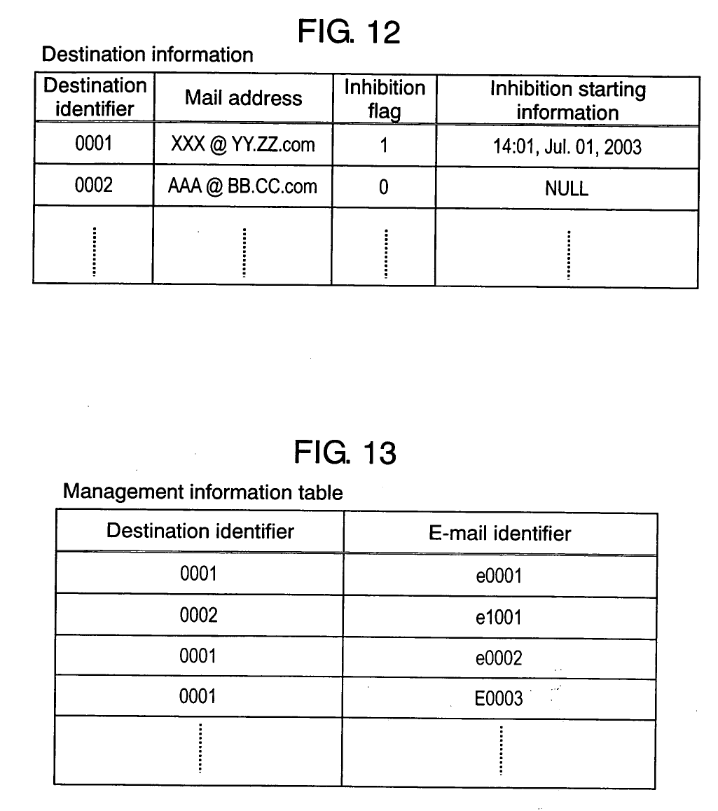

FIG. 12 is a diagram showing examples of the data of the destination information. In FIG. 12, the destination information contains destination identifiers, mail addresses, inhibition flags, inhibition starting information and so on. It is shown that destination identifier “0001” has an inhibition flag at “1” and is excluded from the candidates of the destination.

The untransmitted E-mail information is described in the following. FIG. 13 is a diagram showing data examples of the untransmitted E-mail information. In FIG. 13, the untransmitted E-mail information contains destination identifiers, E-mail identifiers and so on. When error information reception unit 106 receives the error information, untransmitted E-mail information configuring/holding unit 201 updates the untransmitted E-mail information. In case the error information is received from destination identifier “0001”, for example, untransmitted E-mail information configuring/holding unit 201 adds destination identifier “0001” and E-mail identifier “e0001” of the transmitted E-mail to the untransmitted E-mail information. The components of the untransmitted E-mail information should not be limited to the E-mail identifiers but may be either a pointer indicating the place where the E-mail is stored or the E-mail itself. The components of the untransmitted E-mail information should not be limited to the destination identifier but may be the mail address or the like. In case the re-error information is received, too, untransmitted E-mail information configuring/holding unit 201 updates the untransmitted E-mail information. In this embodiment, in case re-error information is received, untransmitted E-mail information configuring/holding unit 201 updates the untransmitted E-mail information but may not update it. In this case, the routine advances to Step S212 in case the re-error information was received at Step S215.

Here will be described the case, in which the untransmitted E-mail is to be transmitted. In case the re-error information has not been received for a predetermined period, E-mail acquisition unit 202 decides it from the untransmitted E-mail information held by untransmitted E-mail information configuring/holding unit 201, and acquires the untransmitted E-mail from mail information storage unit 101. In the case of destination identifier “0001” of destination information n(i), the untransmitted E-mail information is retrieved with the key of destination information “0001”. As a result of the retrieval, there are acquired E-mail identifiers “e0001”, “e0002” and “e0003”. Next, E-mail acquisition unit 202 acquires the E-mails which are discriminated individually with E-mail identifiers “e0001”, “e0002” and “e0003”, from mail information storage unit 101. Next, E-mail transmission unit 105 transmits the E-mails, which are discriminated with E-mail identifiers “e0001”, “e0002” and “e0003” acquired by E-mail acquisition unit 202, to the destination which is specified with the mail address “xxx@yy.zz.com” discriminated with destination identifier “0001”.

According to this embodiment, the untransmitted E-mail can be transmitted to the destination which has been excluded from its candidates. It is possible to avoid the situation, in which only a portion (i.e., an edition of a past month) of the E-mail such as a periodically distributed mail magazine or the like is not transmitted.

In this embodiment, E-mail transmission control device 200 does not restore the excluded destination, but may restore that excluded destination. In this case, E-mail transmission control device 200 further includes a destination restoring unit 111.

The programs of the case in which the operations in this embodiment are realized by the software are as follows. The program causes a computer to further execute: an untransmitted E-Mail configuring/holding step of holding the untransmitted E-mail information on the information of the E-mail which could not be and/or was not transmitted in a manner to correspond to the destination information; a re-error information reception decision step of deciding whether or not the error information has been received from the excluded destination, in case the re-transmission decision step has decided the satisfaction of the predetermined condition after the destination excluding step executed the exclusion so that the E-mail transmission step has transmitted the E-mail to the excluded destination; an E-mail acquisition step of deciding the E-mail, that is made to correspond to the destination information indicating the destination from which the error information has not been transmitted and that could not be and/or was not transmitted, from the untransmitted E-mail information held at the untransmitted E-mail information configuring/holding step, in case it has been decided at the re-error information reception decision step that the error information was not received, and acquiring the E-mail; and a transmission step of transmitting the E-mail acquired at the E-mail acquisition step, to the destination from which the error information has not been transmitted.

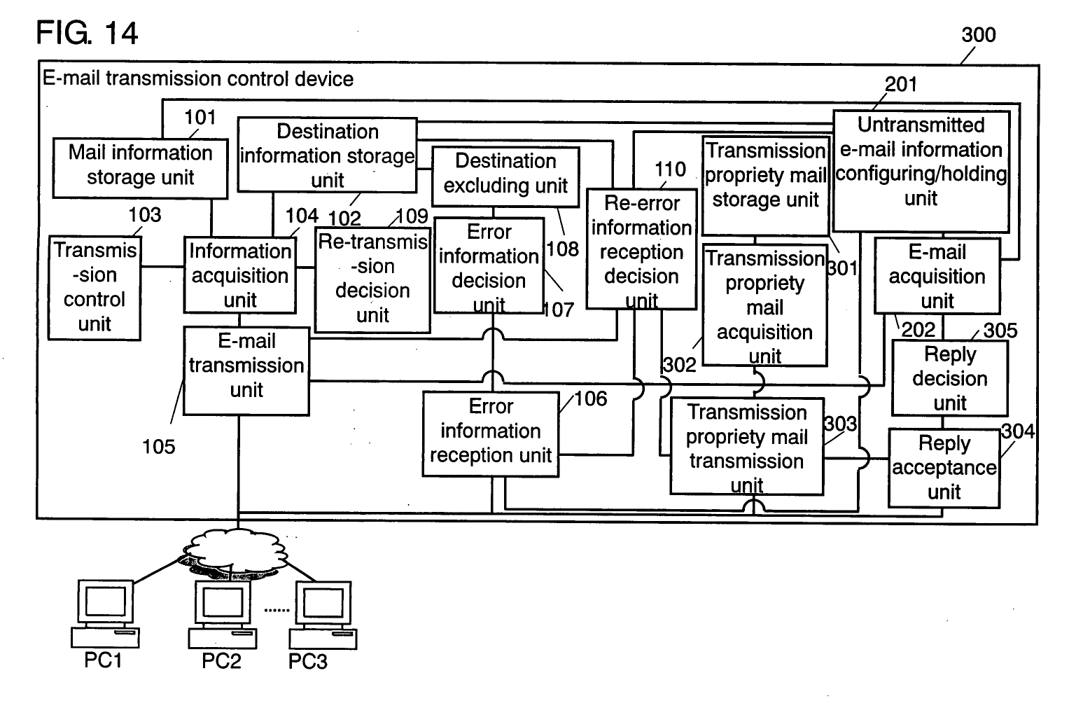

FIG. 14 is a block diagram showing a configuration of another E-mail transmission control device 300 in this embodiment. E-mail transmission control device 300 is configured to include mail information storage unit 101, destination information storage unit 102, transmission control unit 103, information acquisition unit 104, E-mail transmission unit 105, error information reception unit 106, error information decision unit 107, destination excluding unit 108, re-transmission decision unit 109, re-error information reception decision unit 110, untransmitted E-mail information configuring/holding unit 201, E-mail acquisition unit 202, transmission propriety mail storage unit 301, transmission propriety mail acquisition unit 302, transmission propriety mail transmission unit 303, reply acquisition unit 304 and reply decision unit 305.

Transmission propriety mail storage unit 301 is stored with a transmission propriety mail. The phrase “transmission propriety mail” means an E-mail for inquiring the propriety of the transmission of an untransmitted E-mail, as will be specified hereinafter. Transmission propriety mail storage unit 301 is properly exemplified by a nonvolatile record medium but may also be exemplified by a volatile record medium. The transmission propriety mail may be stored in advance in transmission propriety mail storage unit 301 or may also be transmitted from an external device or the like and stored. The transmission propriety mail may also be directly inputted from input accepting means (e.g., an input device). In case the E-mail is directly inputted from the input accepting means (e.g., an input device), the word “stored” means a concept containing a temporary storage in the main memory or the like.

Transmission propriety mail acquisition unit 302 acquires the transmission propriety mail from transmission propriety mail storage unit 301. Transmission propriety mail acquisition unit 302 can be usually realized by an MPU, a memory or the like. The procedure to “acquire” is usually realized by software, which is recorded in a record medium such as a ROM, but may be realized by hardware (or a dedicated circuit).

In case re-error information reception decision unit 110 has decided that the re-error information was not received, transmission propriety mail transmission unit 303 transmits the transmission propriety mail acquired by transmission propriety mail acquisition unit 302, to the destination from which the re-error information has not been transmitted. Transmission propriety mail transmission unit 303 is realized, for example, by including a network card, its driver software and so on.

Reply acceptance unit 304 accepts a reply corresponding to the transmission propriety mail transmitted by transmission propriety mail transmission unit 303. This “acceptance” is a concept containing a reception via the network, a direct acceptance of a manual input, and so on. In the case of a reception via the network, reply acceptance unit 304 is realized, for example, by including a network card, its driver software and so on. In case the reply is directly accepted by a manual input, reply acceptance unit 304 can be realized by input acceptance means, its driver software and so on.

Reply decision unit 305 decides whether or not the “reply” received by reply acceptance unit 304 is the information indicating a transmittability. Reply decision unit 305 can be usually realized by an MPU, a memory or the like. The procedure to “decide” is usually realized by software, which is recorded in a record medium such as a ROM, but may also be realized by a hardware (or a dedicated circuit).

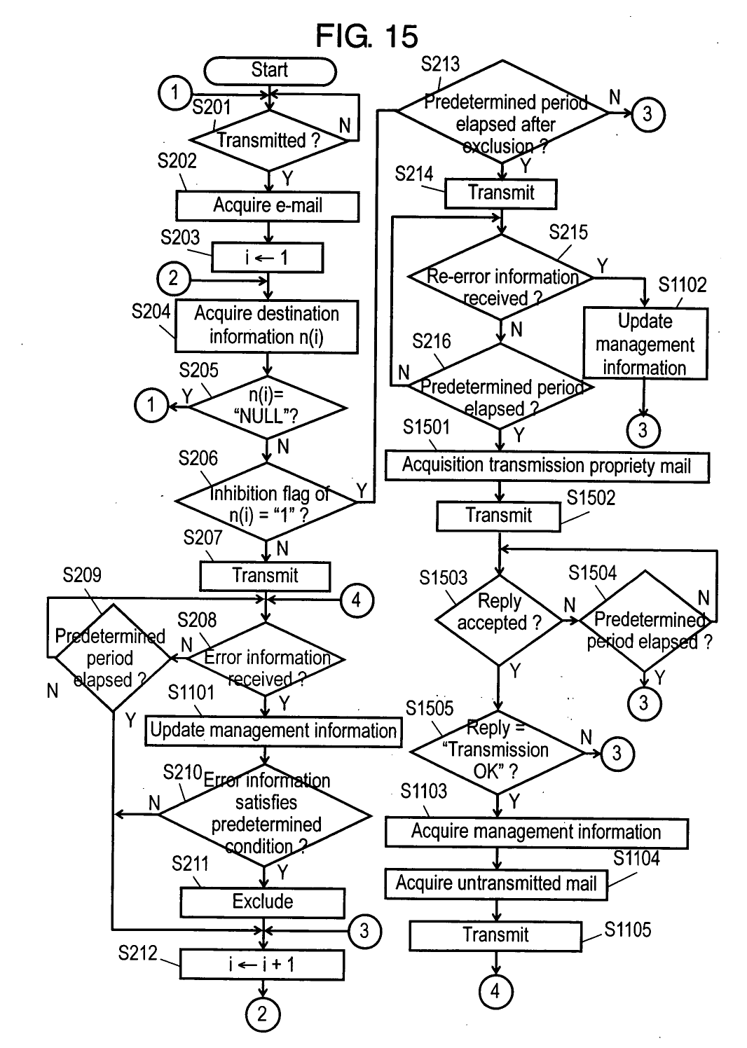

The operations of E-mail transmission control device 300 in this embodiment will be described with reference to the flow chart of FIG. 15. The steps and so on of the flow chart using the common reference numerals perform the common functions in the other embodiment, and their description is omitted.

(At Step S1501): With the decisions of Step S215 and Step S216 that the re-error information has not been received for the predetermined period, transmission propriety acquisition unit 302 acquires the transmission propriety mail from transmission propriety mail storage unit 301.

(At Step S1502): Transmission propriety mail transmission unit 303 transmits the transmission propriety mail acquired at Step S1501, to the destination from which the re-error information has not been transmitted.

(At Step S1503): Reply acceptance unit 304 decides whether or not a reply to the transmission propriety mail transmitted at Step S1502 has been accepted. The routine advances to Step S1504, in case the reply has been accepted, but otherwise to Step S1504.

(At Step S1504): Reply acceptance unit 304 decides whether or not a predetermined time period has elapsed from the time when transmission propriety mail transmission unit 303 transmitted the transmission propriety mail. The routine skips to Step S212, in case the predetermined period has elapsed, but otherwise returns to Step S1503.

(At Step S1505): Reply decision unit 305 decides whether or not the information on the reply received at Step S1503 indicates the transmittability. The routine advances to Step S1103, in the case of the information indicating the transmittability, but otherwise skips to Step S212.

Here will be described the specific operations of E-mail transmission control device 300 in this embodiment. Conceptional diagram of E-mail transmission control device 300 is similar to that of FIG. 3, and its description is omitted.

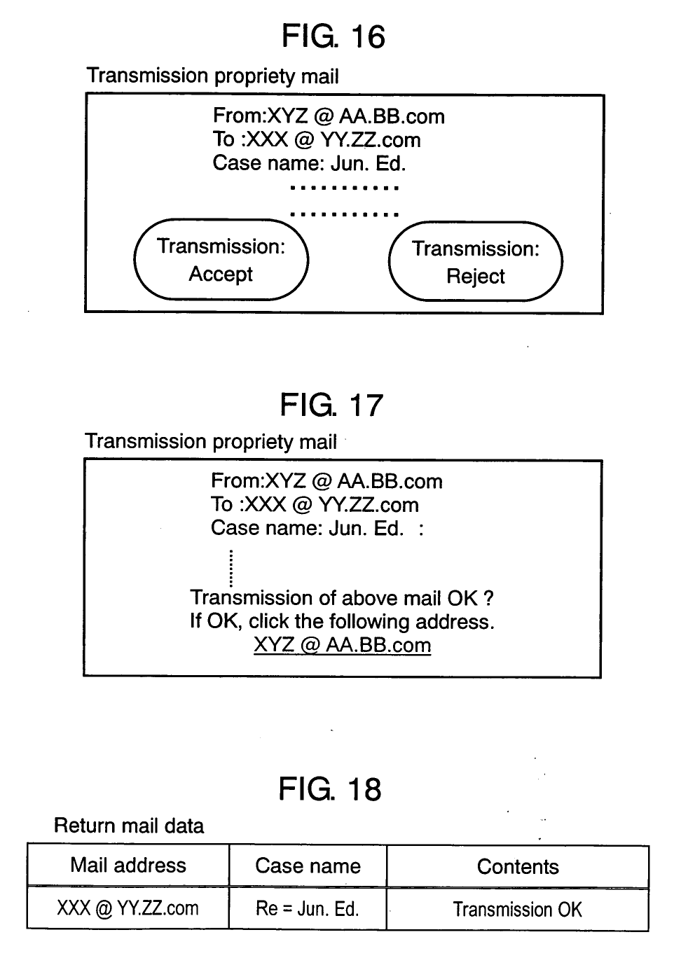

The transmission of the transmission propriety mail and the reply to the mail are described in the following. Transmission propriety mail transmission unit 303 transmits the transmission propriety mail, as shown in FIG. 16 or FIG. 17, for example, to the destination, from which the re-error information was not transmitted. FIG. 16 and FIG. 17 are diagrams showing data examples of the transmission propriety mail. In FIG. 16, the transmission propriety mail contains a button display of “TRANSMISSION: ACCEPT” and a button display of “TRANSMISSION: REJECT”. When the “TRANSMISSION: ACCEPT” button is clicked, a reply having the information of “TRANSMISSION: ACCEPT” is transmitted to E-mail transmission control device 300. When the button of “TRANSMISSION: REJECT” is clicked, a reply having the information of “TRANSMISSION: REJECT” is transmitted to E-mail transmission control device 300. When the underlined mail address “Mail@xx.xx.com” is clicked, as shown in FIG. 17, a reply having the information of “TRANSMISSION: ACCEPT” is transmitted to E-mail transmission control device 300.

Next, reply decision unit 305 decides whether or not the reply accepted by reply acceptance unit 304 is the information indicating the “TRANSMISSION: ACCEPT”. FIG. 18 shows the contents of the replied data. In FIG. 18, the contents of the replied data have the mail address, the case name of the E-mail, the contents of the transmission propriety, and so on. Now, the replied data contain the information of the “TRANSMISSION: ACCEPT”. In this case, E-mail acquisition unit 202 acquires the untransmitted E-mail information and retrieves the untransmitted E-mail information to acquire the E-mail identifier. By keying the E-mail identifier, the untransmitted E-mail is acquired from mail information storage unit 101. E-mail transmission unit 105 transmits the untransmitted E-mail acquired, to the destination which is defined with the mail address “xxx@yy.zz.com” of the replied data.

According to this embodiment, before the untransmitted E-mail is transmitted, a questionaire (or a transmission propriety mail) about the transmission propriety is transmitted, and the reply is received. As a result, the unnecessary mail need not be transmitted so that the load on the E-mail transmission control device can be reduced.

In this embodiment, E-mail transmission control device 300 does not but may restore the excluded destination. In this case, E-mail transmission control device 300 further includes a destination restoring unit 111.

The programs of the case in which the operations in this embodiment are realized by the software are as follows. The program causes the computer to further execute: a transmission propriety mail transmission step of transmitting a transmission propriety mail or an E-mail inquiring the propriety of the transmission of the untransmitted mail to the destination, in case it has been decided at the re-error information reception decision step that the error information was not received; a reply acceptance step of accepting a reply corresponding to the transmission propriety mail transmitted at the transmission propriety mail transmission step; and an acquisition step of deciding and acquiring the E-mail, that is made to correspond to the destination information indicating the destination from which the error information has not been transmitted and that could not be and/or was not transmitted, from the untransmitted E-mail information held at the untransmitted E-mail information configuring/holding step, in case the reply is accepted at the reply acceptance step and in case the reply indicates a transmittability.

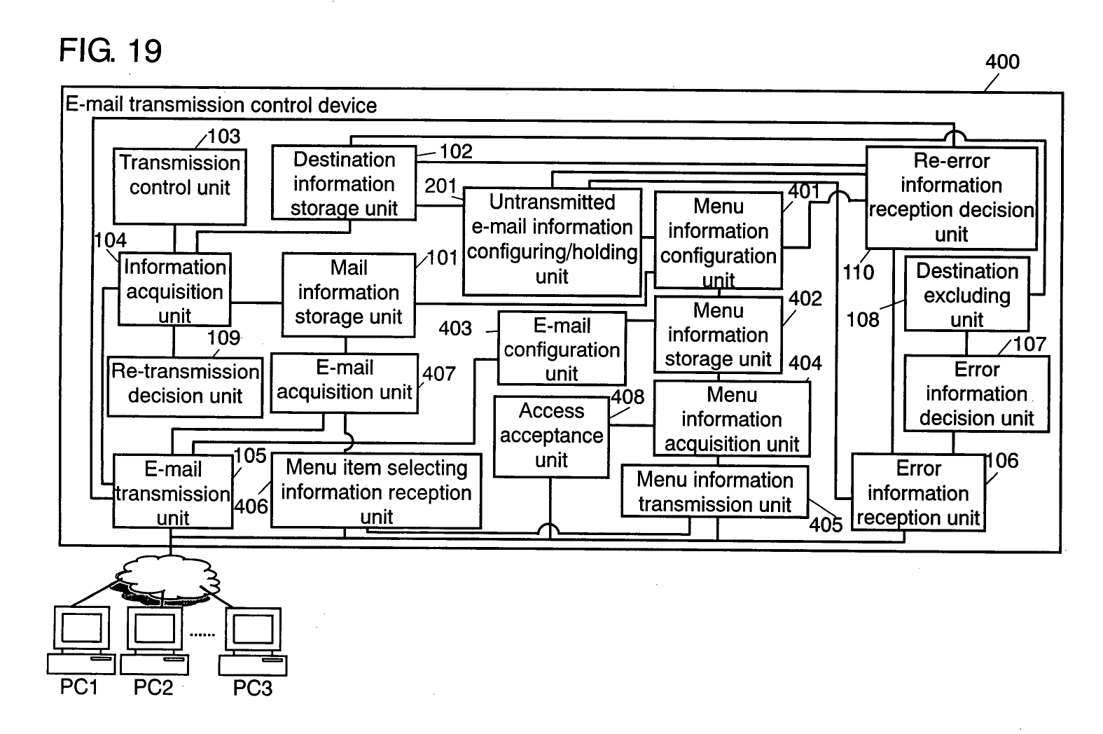

FIG. 19 is a block diagram showing a configuration of another E-mail transmission control device 400 in this embodiment. E-mail transmission control device 400 is configured to include mail information storage unit 101, destination information storage unit 102, transmission control unit 103, information acquisition unit 104, E-mail transmission unit 105, error information reception unit 106, error information decision unit 107, destination excluding unit 108, re-transmission decision unit 109, re-error information reception decision unit 110, untransmitted E-mail information configuring/holding unit 201, menu information configuration unit 401, menu information storage unit 402, E-mail configuration unit 403, menu information acquisition unit 404, menu information transmission unit 405, menu item selecting information reception unit 406, E-mail acquisition unit 407, and access acceptance unit 408.

In case re-error information reception decision unit 110 has decided that the error information was not received, menu information configuration unit 401 decides the E-mail, that is made to correspond to the destination information indicating the destination having untransmitted the error information, from which the error information has not been transmitted, and that could not be and/or was not transmitted to the destination, from the untransmitted E-mail information held by untransmitted E-mail information configuring/holding unit 201, and configures the menu information which contains, as a menu item, the E-mail specifying information to specify the E-mail from the information discriminating the E-mail. The phrase “E-mail specifying information” is the information specifying the E-mail, that is, the E-mail specifying information such as the summary and case name of the E-mail, the information of the transmitter, the date of transmission and others. Menu information configuration unit 401 can be usually realized by an MPU, a memory and so on. The procedure to “configure the menu information” is usually realized by software, which is recorded in a record medium such as a ROM, but may also be realized by hardware (or a dedicated circuit).

Menu information storage unit 402 stores in the record medium the menu information configured by menu information configuration unit 401. The word “storage” is a concept containing a temporary storage. The place “to store” may be either a record medium packaged in E-mail transmission control device 400 or a record medium owned by an external device or the like. Menu inhibition flag storage unit 402 can be usually realized by an MPU, a memory or the like. The procedure to “store” is usually realized by software, which is recorded in a record medium such as a ROM, but may also be realized by hardware (or a dedicated circuit).

E-mail configuration unit 403 configures the E-mail which contains the place specifying information or the information specifying the existential place of the menu information stored by menu information storage unit 402. The phrase “place specifying information” is exemplified by a URL, a URI or the like. E-mail configuration unit 403 can be usually realized by an MPU, a memory or the like. The procedure to “configure the E-mail” is usually realized by software, which is recorded in a record medium such as a ROM, but may also be realized by hardware (or a dedicated circuit).

Menu information acquisition unit 404 acquires the menu information which is stored by menu information storage unit 402. Menu inhibition flag acquisition unit 404 can be usually realized by an MPU, a memory or the like. The procedure to “acquire the menu information” is usually realized by software, which is recorded in a record medium such as a ROM, but may also be realized by hardware (or a dedicated circuit).

In case access acceptance unit 408 accepts an access to the place specifying information, menu information transmission unit 405 transmits the menu information acquired by menu information acquisition unit 404, to the destination from which the re-error information has not been transmitted. Menu information transmission unit 405 is realized, for example, by including a network card, its driver software and so on.

Menu item selecting information reception unit 406 receives the menu item selecting information in response to the transmission of the menu information of menu information transmission unit 405. The phrase “menu item selecting information” is the information on the E-mail specifying information selected from the menu items. Menu item selecting information reception unit 406 is realized, for example, by including a network card, its driver software and so on.

E-mail acquisition unit 407 acquires the E-mail, which is specified with the menu item indicated by the menu item selecting information received by menu item selecting information reception unit 406, from the E-mail which is stored in mail information storage unit 101. E-mail acquisition unit 407 can be usually realized by an MPU, a memory or the like. The procedure to “acquire” is usually realized by software, which is recorded in a record medium such as a ROM, but may also be realized by hardware (or a dedicated circuit).

Access acceptance unit 408 accepts an access to the place specifying information. Access acceptance unit 408 is realized, for example, by including a network card, its driver software and so on. Access means may be any of http, Gopher, ftp, Wais and so on.

E-mail transmission unit 105 transmits the E-mail acquired by E-mail acquisition unit 202, to the destination, from which the re-error information was not transmitted.

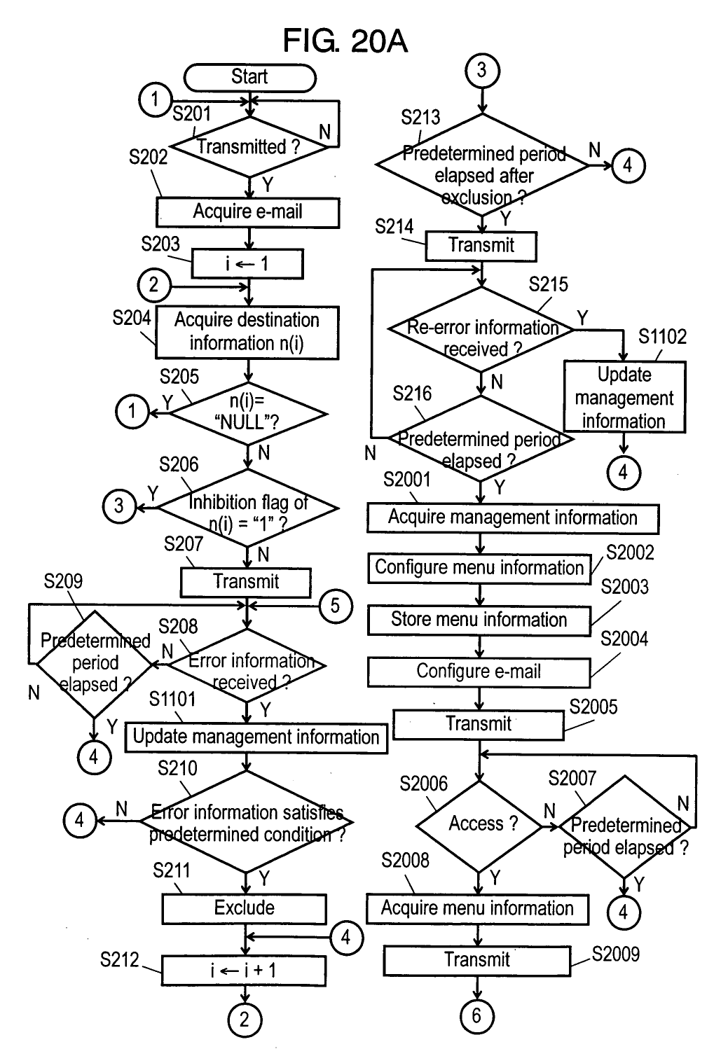

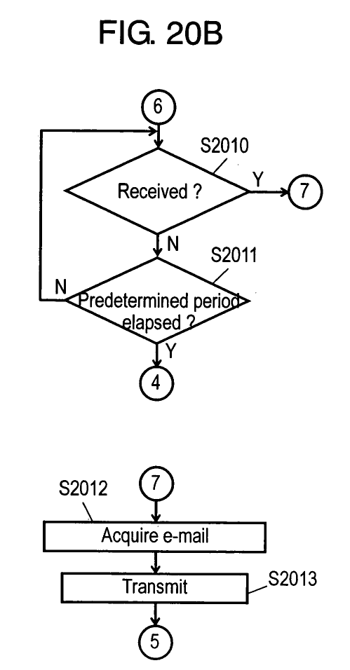

The operations of E-mail transmission control device 400 in this embodiment will be described with reference to the flow chart of FIG. 20A and FIG. 20B. The steps and so on of the flow chart using the common reference numerals perform the common functions in the other embodiment, and their description is omitted.

(At Step S2001): With the decisions of Step S215 and Step S216 that the re-error information has not been received for the predetermined period, menu information configuration unit 401 acquires the untransmitted E-mail information from untransmitted E-mail information configuring/holding unit 201.

(At Step S2002): Menu information configuration unit 401 retrieves the untransmitted E-mail information with a key of the destination identifier of the destination, from which the re-error information was not transmitted, and acquires the E-mail identifier (as referred to FIG. 13). Next, menu information configuration unit 401 acquires the E-mail discriminated with the acquired E-mail identifier, from mail information storage unit 101. Next, menu information configuration unit 401 retrieves the E-mail specifying information such as the case name, the summary or the information of the transmitter, from the E-mail acquired. Next, menu information configuration unit 401 configures the menu information containing menu items such as the case name and summary of the acquired E-mail, the information on the transmitter, and so on.

(At Step S2003): Menu information storage unit 402 stores the menu information configured at Step S2002.

(At Step S2004): E-mail configuration unit 403 configures the E-mail containing the place specifying information or the information specifying the existential place of the menu information.

(At Step S2005): E-mail transmission unit 105 transmits the E-mail configured at Step S2004, to the destination, from which the re-error information was not transmitted.

(At Step S2006): Access acceptance unit 408 decides whether or not an access to the place specifying information owned by the E-mail transmitted at Step S2005 has been accepted. The routine advances to Step S2008, in case the access was accepted, but otherwise to Step S2007.

(At Step S2007): Access acceptance unit 408 decides whether or not a predetermined period has elapsed from the time when the E-mail was transmitted at Step S2005. The routine skips to Step S212, in case the predetermined period has elapsed, but otherwise returns to Step S2006.

(At Step S2008): Menu information acquisition unit 404 acquires the menu information because access acceptance unit 408 accepted the access to the place specifying information for the predetermined period at Step S2006 and at Step S2007.

(At Step S2009): Menu information transmission unit 405 transmits the menu information acquired at Step S2008, to the destination, from which the re-error information was not transmitted.

(At Step S2010): Menu item selecting information reception unit 406 decides whether or not the menu item selecting information has been received. The routine advances to Step S2012, in case the menu item selecting information was received, but otherwise to Step S2011.

(At Step S2011): Menu item selecting information reception unit 406 decides whether or not the predetermined period has elapsed from the time when the menu information was transmitted at Step S2009. The routine skips to Step S212, in case the predetermined period has elapsed, but otherwise returns to Step S2010.

(At Step S2012): E-mail acquisition unit 407 acquires the E-mail which is specified on the basis of the menu item selecting information received at Step S2010, from mail information storage unit 101.

(At Step S2013): E-mail transmission unit 105 transmits the E-mail acquired at Step S2012, to the destination, to which the menu information was transmitted. The routine returns to Step S208.

The specific operations of E-mail transmission control device 400 in this embodiment will be described. The conceptional diagram of E-mail transmission control device 400 is similar to that of FIG. 3, and its description is omitted.

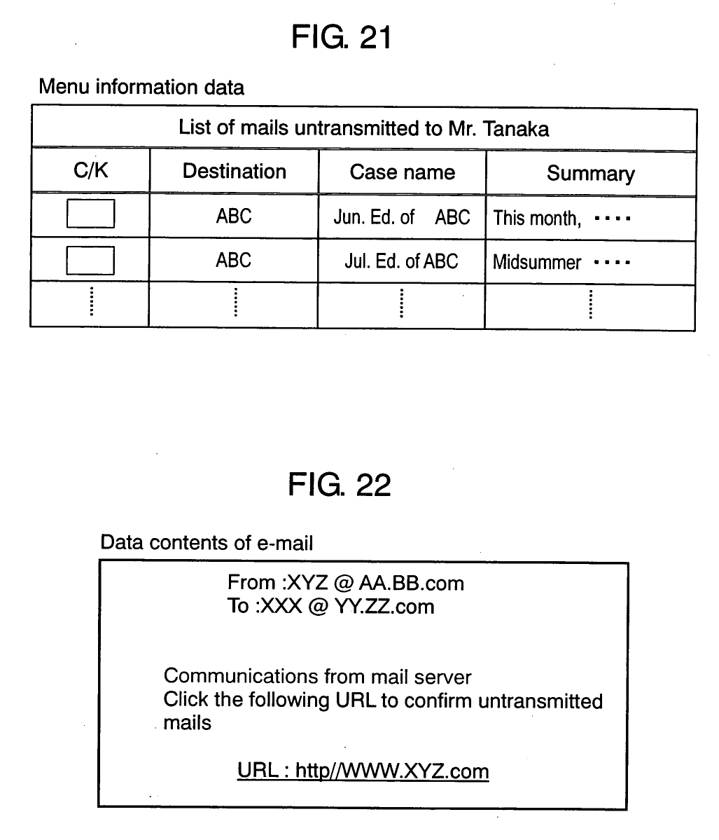

Here will be described the case, in which the menu information is to be transmitted. Menu information configuration unit 401 configures the menu information when re-error information reception decision unit 110 decides that the re-error information has not been received for the predetermined period. FIG. 21 is a diagram showing data examples of the menu information. In FIG. 21, the menu information is configured to contain check boxes, transmitters of the untransmitted E-mails, case names, summaries and so on. The E-mail specifying information of the menu items owned by the menu information may be the information other than the transmitters, the case names, the summaries and so on, or may also be the information specifying the untransmitted E-mail. Next, a menu information storage unit 402 stores that menu information. Next, E-mail configuration unit 403 configures the E-mail having the place specifying information or the information specifying the existential place of the menu information stored. FIG. 22 is a diagram showing data examples of the E-mail. In FIG. 22, the data of the E-mail contains the information of the place specifying information. Next, E-mail transmission unit 105 transmits the E-mail containing that place specifying information. When the place specifying information owned by that E-mail is clicked by the user of the transmitter, access acceptance unit 408 accepts the access to that place specifying information. Next, menu information acquisition unit 404 acquires the menu information stored by menu information storage unit 402. Next, menu information transmission unit 405 transmits the acquired menu information to the terminal being accessed to.

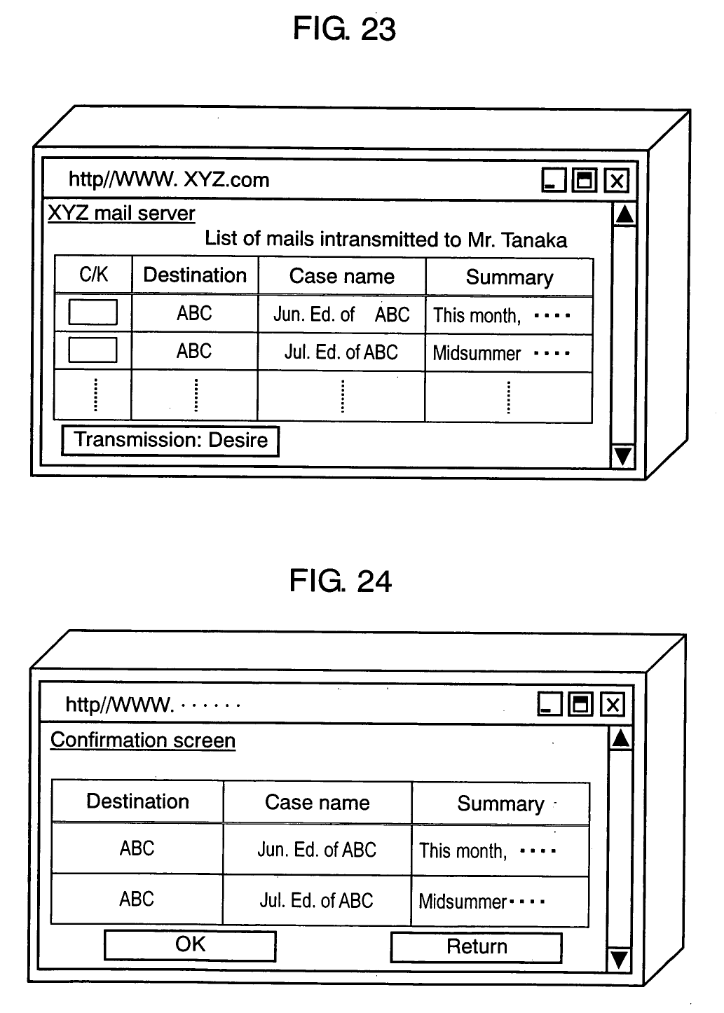

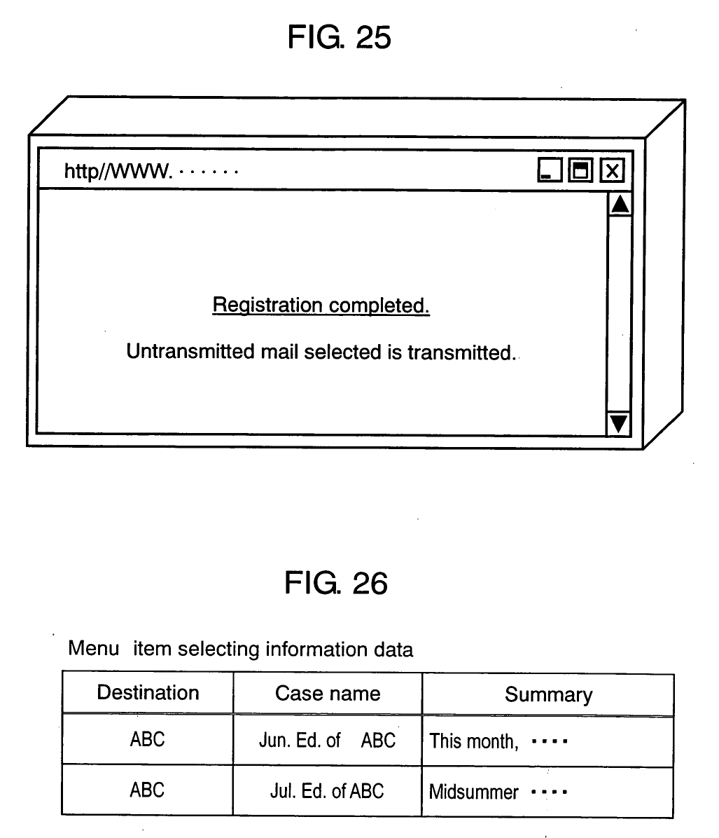

Here will be described the case, in which the menu item selecting information is to be received. FIG. 23 is a diagram showing a display example of the menu information displayed on the display screen of the user. In FIG. 23, a confirmation screen is displayed when the check box is checked, and when the “TRANSMISSION: DESIRE” button is clicked. FIG. 24 is a diagram showing a display example of the confirmation screen. In FIG. 24, a registration completed screen shown in FIG. 25 is displayed when the “OK” button is clicked. When the “RETURN” button is clicked, on the other hand, the display returns to the menu information display screen shown in FIG. 23. The display screen, the confirmation screen and the registration complete screen of the menu information should not be limited to those of this embodiment but may be others. When the “OK” button is clicked, the menu item selecting information is configured. FIG. 26 is a diagram showing a data example of the menu information selecting information. In FIG. 26, the menu item selecting information contains the information such as the transmitters, the case names, the summaries and so on. The menu item selecting information may be the information other than the transmitters, the case names, the summaries and so on, or may also be the information specifying the untransmitted E-mail. Next, the menu item selecting information configured is transmitted to E-mail transmission control device 400. The menu item selecting information is received by menu item selecting information reception unit 406. Next, E-mail acquisition unit 407 retrieves the E-mail stored in mail information storage unit 101, with a key of the menu item selecting information received. Next, E-mail transmission unit 105 transmits that E-mail acquired.

According to this embodiment, only the E-mail that is selected by the user of the destination excluded from the candidates of the destination can be transmitted to that destination address. As a result, the unnecessary mail need not be transmitted so that the load on the E-mail transmission control device can be reduced.

In this embodiment, E-mail transmission control device 400 does not but may restore the excluded destination. In this case, E-mail transmission control device 400 further includes destination restoring unit 111.

The programs of the case in which the operations in this embodiment are realized by the software are as follows. The program causes the computer to further execute: an untransmitted E-Mail configuring/holding step of holding the untransmitted E-mail information on the information of the E-mail which could not be and/or was not transmitted in a manner to correspond to the destination information; a re-error information reception decision step of deciding whether or not the error information has been received from the excluded destination, in case the re-transmission decision step has decided the satisfaction of the predetermined condition after the destination excluding step executed the exclusion so that the E-mail has been transmitted to the excluded destination; a menu information configuration step of deciding the E-mail, that is made to correspond to the destination information indicating the destination, from which the error information has not been transmitted, and that could not be and/or was not transmitted to the destination, from the untransmitted E-mail information held at the untransmitted E-mail information configuring/holding step, in case it has been decided at the re-error information reception decision step that the error information was not received, and configuring menu information containing, as a menu item, E-mail specifying information to specify the E-mail from the information for discriminating the E-mail; a menu information storage step of storing the menu information configured at the menu information configuration step; an E-mail configuration step of configuring an E-mail containing place specifying information or the information for specifying the existential place of the menu information stored at the menu information storage step; a menu information transmission step of transmitting the E-mail configured at the E-mail configuration step, and accepting an access to the place specifying information and for transmitting the menu information to the destination; a menu item selecting information reception step of receiving menu item selecting information or the information for selecting the menu item in response to the transmission of the menu information of the menu information transmission step; an E-mail acquisition step of acquiring the E-mail which is specified with the menu item indicated by the menu item selecting information received at the menu item selecting information reception step; and a transmission step of transmitting the E-mail acquired at the E-mail acquisition step, to the destination from which the error information has not been transmitted.

In this embodiment, moreover, E-mail transmission control device 400 has the place which is specified with the place specifying information, and accepts an access from the user terminal, but may not have that place. In this case, E-mail transmission control device 400 may not be provided with menu information transmission unit 405. Menu information storage unit 402 stores the menu information at the place (e.g., usually an external device), which is defined with the place specifying information. The user terminal makes access to the place defined by that place specifying information, and peruses the menu information to select the untransmitted E-mail from the menu item owned by the menu information.

The programs of the case in which the operations in this embodiment are realized by the software are as follows. The program causes the computer to further execute: an untransmitted E-Mail configuring/holding step of holding the untransmitted E-mail information on the information of the E-mail which could not be and/or was not transmitted in a manner to correspond to the destination information; a re-error information reception decision step of deciding whether or not the error information has been received from the excluded destination, in case the re-transmission decision step has decided the satisfaction of the predetermined condition after the exclusion was executed at the destination excluding step so that the E-mail has been transmitted to the excluded destination; a menu information configuration step of deciding the E-mail, that is made to correspond to the destination information indicating the destination, from which the error information has not been transmitted, and that could not be and/or was not transmitted to the destination, from the untransmitted E-mail information held by the untransmitted E-mail information configuring/holding step, in case it has been decided at the re-error information reception decision step that the error information was not received, and configuring menu information containing, as a menu item, E-mail specifying information to specify the E-mail from the information for discriminating the E-mail; a menu information storage step of storing the menu information configured at the menu information configuration step; an E-mail configuration step of configuring an E-mail containing place specifying information or the information for specifying the existential place of the menu information stored at the menu information storage step; a menu item selecting information reception step of transmitting the E-mail configured at the E-mail configuring step to the destination and receiving selected menu item selecting information from the menu item owned by the menu information; an E-mail acquisition step of acquiring the E-mail which is specified with the menu item indicated by the menu item selecting information received at the menu item selecting information reception step; and a transmission step of transmitting the E-mail acquired at the E-mail acquisition step, to the destination from which the error information has not been transmitted.

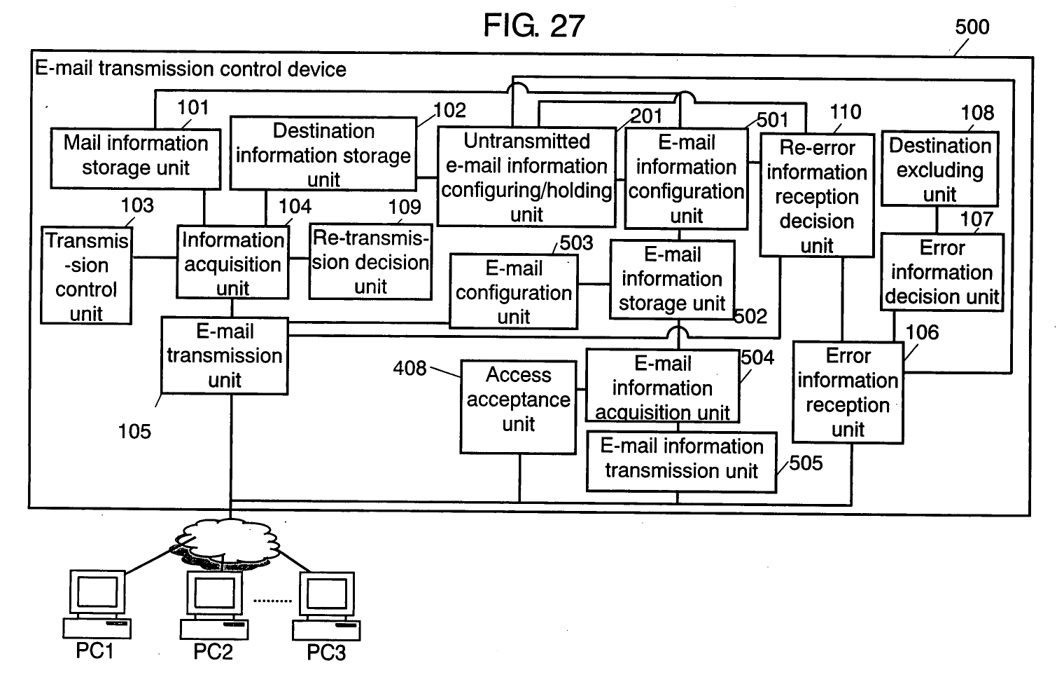

FIG. 27 is a block diagram showing a configuration of another E-mail transmission control device 500 in this embodiment. E-mail transmission control device 400 is configured to include mail information storage unit 101, destination information storage unit 102, transmission control unit 103, information acquisition unit 104, E-mail transmission unit 105, error information reception unit 106, error information decision unit 107, destination excluding unit 108, re-transmission decision unit 109, re-error information reception decision unit 110, untransmitted E-mail information configuring/holding unit 201, E-mail information configuration unit 501, E-mail information storage unit 502, E-mail configuration unit 503, E-mail information acquisition unit 504, E-mail information transmission unit 505, and access acceptance unit 408.

In case re-error information reception decision unit 110 has decided that the re-error information was not received, E-mail information transmission unit 501 decides the E-mail, that is made to correspond to the destination information indicating the destination, from which the error information has not been transmitted, and that could not be and/or was not transmitted to the destination, from the untransmitted E-mail information held by untransmitted E-mail information configuring/holding unit 201, and configures the E-mail information which contains that E-mail. The phrase “E-mail information” is the information having at least one piece of untransmitted E-mail. E-mail information configuration unit 501 can be usually realized by an MPU, a memory and so on. The procedure to “configure the E-mail information” is usually realized by software, which is recorded in a record medium such as a ROM, but may also be realized by hardware (or a dedicated circuit).

E-mail information storage unit 502 stores the E-mail information configured by E-mail information configuration unit 501. The word “storage” is a concept containing a temporary storage. The plane “to store” may be either a record medium packaged in E-mail transmission control device 500 or a record medium owned by an external device or the like. E-mail information storage unit 502 can be usually realized by an MPU, a memory or the like. The procedure to “store the E-mail information” is usually realized by software, which is recorded in a record medium such as a ROM, but may also be realized by hardware (or a dedicated circuit).

E-mail configuration unit 503 configures the E-mail which contains the place specifying information or the information specifying the existential place of the E-mail information stored by E-mail information storage unit 502. The phrase “place specifying information” is exemplified by a URL, a URI or the like. E-mail configuration unit 503 can be usually realized by an MPU, a memory or the like. The procedure to “configure the E-mail” is usually realized by software, which is recorded in a record medium such as a ROM, but may also be realized by hardware (or a dedicated circuit).

E-mail information acquisition unit 504 acquires the E-mail information which is stored by E-mail information storage unit 502. E-mail information acquisition unit 504 can be usually realized by an MPU, a memory or the like. The procedure to “acquire the E-mail information” is usually realized by software, which is recorded in a record medium such as a ROM, but may also be realized by hardware (or a dedicated circuit).

E-mail information transmission unit 505 transmits the E-mail information acquired by E-mail information acquisition unit 504, to the destination from which the re-error information has not been transmitted. E-mail information transmission unit 505 is realized, for example, by including a network card, its driver software and so on.

E-mail transmission unit 105 transmits the E-mail configured by E-mail configuration unit 503, to the destination, from which the re-error information was not transmitted.

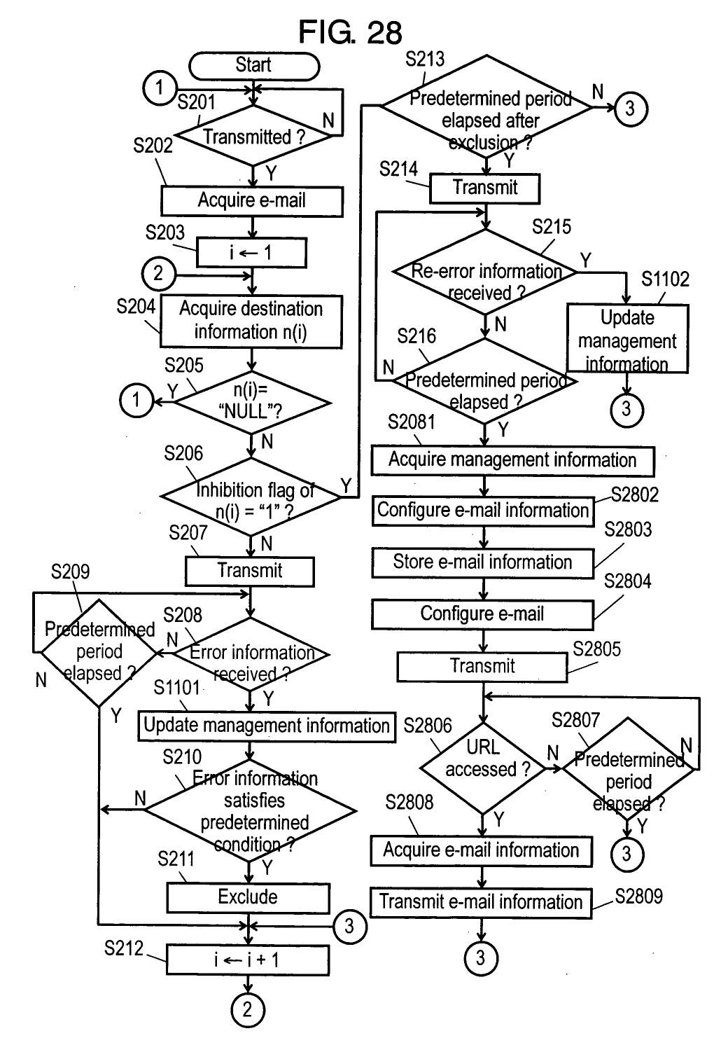

The operations of E-mail transmission control device 500 in this embodiment will be described with reference to the flow chart of FIG. 28. The steps and so on of the flow chart using the common reference numerals perform the common functions in the other embodiment, and their description is omitted.

(At Step S2801): With the decisions of Step S215 and Step S216 that the re-error information has not been received for the predetermined period, E-mail information configuration unit 501 acquires the untransmitted E-mail information from untransmitted E-mail information configuring/holding unit 201.

(At Step S2802): E-mail information configuration unit 501 retrieves the untransmitted E-mail information with a key of the destination identifier of the destination, from which the re-error information was not transmitted, and acquires the E-mail identifier (as referred to FIG. 13). Next, E-mail information configuration unit 501 acquires the E-mail discriminated with the acquired E-mail identifier, from mail information storage unit 101. Next, E-mail information configuration unit 501 configures the E-mail information containing the acquired E-mail.

(At Step S2803): E-mail information storage unit 502 stores the E-mail information configured at Step S2802.

(At Step S2804): E-mail configuration unit 503 configures the E-mail containing the place specifying information or the information specifying the existential place of the E-mail information.

(At Step S2805): E-mail transmission unit 105 transmits the E-mail configured at Step S2804, to the destination, from which the re-error information was not transmitted.

(At Step S2806): Access acceptance unit 408 decides whether or not an access to the place specifying information owned by the E-mail transmitted at Step S2805 has been accepted. The routine advances to Step S2808, in case the access was accepted, but otherwise to Step S2807.

(At Step S2807): Access acceptance unit 408 decides whether or not a predetermined period has elapsed from the time when the E-mail was transmitted at Step S2805. The routine skips to Step S212, in case the predetermined period has elapsed, but otherwise returns to Step S2806.

(At Step S2808): E-mail information acquisition unit 504 acquires the E-mail information because access acceptance unit 408 accepted the access to the place specifying information for the predetermined period at Step S2806 and at Step S2807.

(At Step S2809): E-mail information transmission unit 505 transmits the E-mail information acquired at Step S2808, to the destination, from which the re-error information was not transmitted. The routine skips to Step S212.

The specific operations of E-mail transmission control device 500 in this embodiment will be described. The conceptional diagram of E-mail transmission control device 500 is similar to that of FIG. 3, and its description is omitted.

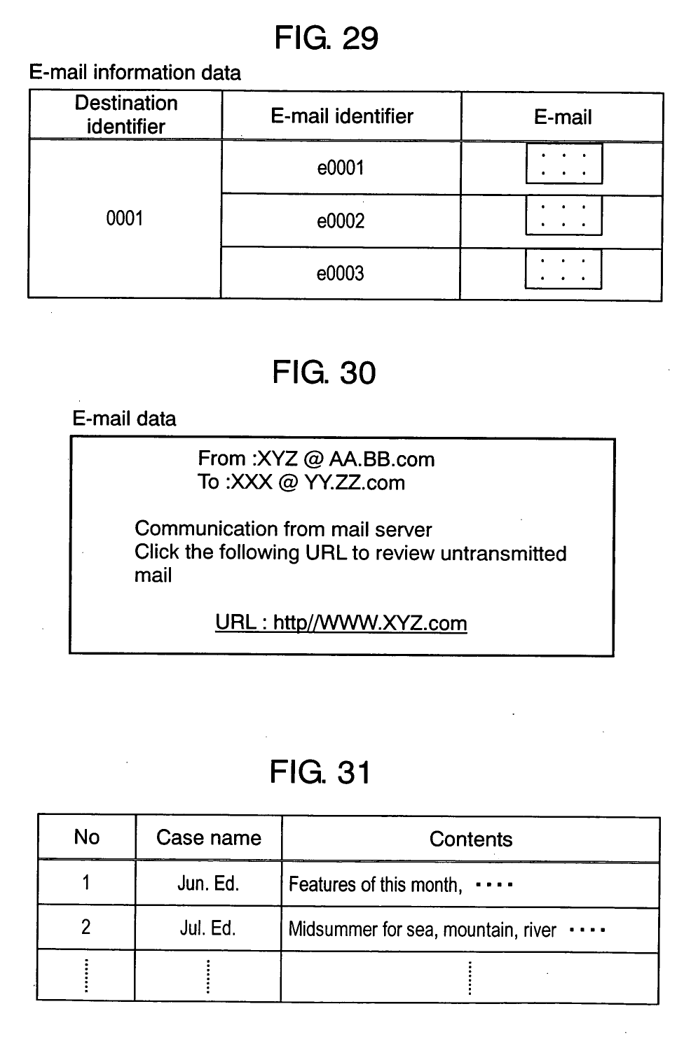

Here will be described the case, in which the E-mail information is to be transmitted. E-mail information configuration unit 501 configures the E-mail information when the re-error information has not been received for the predetermined period. The specific configuration method is as follows. E-mail information configuration unit 501 acquires the untransmitted E-mail information from untransmitted E-mail information configuring/holding unit 201. Next, E-mail information configuration unit 501 retrieves the untransmitted E-mail information with a key of the destination identifier of the destination, from which the re-error information has not been transmitted. Next, E-mail information configuration unit 501 retrieves mail information storage unit 101 with a key of the E-mail identifier obtained by the retrieval. Next, E-mail information configuration unit 501 configures the E-mail information having the E-mail obtained by the retrieval. FIG. 29 is a diagram showing data examples of the E-mail information. In FIG. 29, the E-mail information contains a destination identifier, E-mail identifiers and E-mails. Next, E-mail information storage unit 502 stores the E-mail information configured. Here, the word “storage” includes the temporary storage in the main memory or the like.

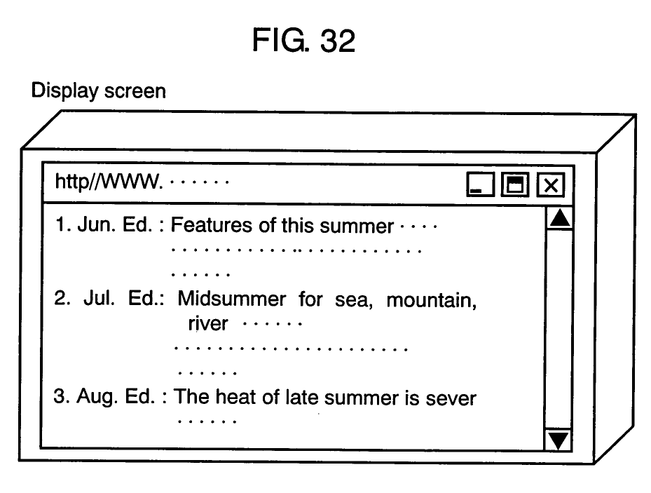

Next, E-mail configuration unit 503 configures the E-mail containing the place specifying information or the information specifying the existential place of the E-mail information. FIG. 30 is a diagram showing an example of the E-mail. When the underlined URL is clicked in FIG. 30, an access is made to the Web site indicated by that URL. Access acceptance unit 408 accepts that access. Next, E-mail information acquisition unit 504 acquires the E-mail information stored by E-mail information storage unit 502, because access acceptance unit 408 has accepted the access. Next, E-mail information transmission unit 505 transmits the E-mail information acquired by E-mail information acquisition unit 504, to the terminal accessed to. FIG. 31 is a diagram showing examples of the E-mail information to be transmitted. FIG. 32 is a diagram showing examples of the display screen displaying the E-mail information.

According to this embodiment, even if the untransmitted E-mail is not transmitted again to the destination excluded from the destination candidates, the untransmitted E-mail can be displayed on the Web site so that the user can peruse the untransmitted mail.

In this embodiment, E-mail transmission control device 500 does not but may restore the excluded destination. In this case, E-mail transmission control device 500 further includes destination restoring unit 111.

The programs of the case in which the operations in this embodiment are realized by the software are as follows. The program causes the computer to further execute: an untransmitted E-Mail configuring/holding step of holding the untransmitted E-mail information on the information of the E-mail which could not be and/or was not transmitted in a manner to correspond to the destination information; a re-error information reception decision step of deciding whether or not the error information has been received from the excluded destination, in case the re-transmission decision step has decided the satisfaction of the predetermined condition after the exclusion was executed at the destination excluding step so that the E-mail has been transmitted to the excluded destination; an E-mail information configuration step of deciding the E-mail, that is made to correspond to the destination information indicating the destination from which the error information has not been transmitted and that could not be and/or was not transmitted, from the untransmitted E-mail information held at the untransmitted E-mail information configuring/holding step, in case it has been decided at the re-error information reception decision step that the error information was not received, and configuring the E-mail information containing the E-mail; an E-mail information storage step of storing the E-mail information configured at the E-mail information configuration step; an E-mail configuration step of configuring an E-mail containing place specifying information or the information for specifying the existential place of the E-mail information stored at the E-mail information storage step; a transmission step of transmitting the E-mail configured at the E-mail configuration step, to the destination from which the error information has not been transmitted; and an E-mail information transmission step of accepting an access to the place specifying information and transmitting the E-mail information to the destination from which the error information has not been transmitted.

In this embodiment, moreover, E-mail transmission control device 500 has the place which is specified with the place specifying information, and accepts an access from the user terminal, but may not have that place. In this case, E-mail transmission control device 500 may not be provided with E-mail information transmission unit 505. E-mail information storage unit 502 stores the E-mail information at the place (e.g., usually an external device), which is defined with the place specifying information. The user terminal makes access to the place defined by that place specifying information, and can confirm the untransmitted E-mail information by perusing the E-mail information.

The programs of the case in which the operations in this embodiment are realized by the software are as follows. The program causes the computer to further execute: an untransmitted E-Mail configuring/holding step of holding configuring the untransmitted E-mail information on the information of the E-mail which could not be and/or was not transmitted in a manner to correspond to the destination information; a re-error information reception decision step of deciding whether or not the error information has been received from the excluded destination, in case the re-transmission decision step has decided the satisfaction of the predetermined condition after the exclusion was executed at the destination excluding step so that the E-mail has been transmitted to the excluded destination at the E-mail transmission step; an E-mail information configuration step of deciding the E-mail, that is made to correspond to the destination information indicating the destination from which the error information has not been transmitted and that could not be and/or was not transmitted, from the untransmitted E-mail information held at the untransmitted E-mail information configuring/holding step, in case it has been at the re-error information reception decision step that the error information was not received, and for configuring the E-mail information containing the E-mail; an E-mail information storage step of storing the E-mail information configured at the E-mail information configuration step; an E-mail configuration step of configuring an E-mail containing place specifying information or the information for specifying the existential place of the E-mail information stored at the E-mail information storage step; and a transmission step of transmitting the E-mail configured at the E-mail configuration step, to the destination.

As has been described hereinbefore, the invention has an effect that the E-mail or the information on the E-mail can be transmitted to the destination excluded from the destination candidates, if the predetermined conditions are satisfied, and is used especially for the E-mail transmission control device or the like for controlling the transmissions of the E-mail.

1. An E-mail transmission control device comprising:
a mail information storage unit stored with mail information or information on an E-mail;
a destination information storage unit stored with one or more pieces of information or information indicating a destination of the E-mail;
an E-mail transmission unit for transmitting an E-mail to the destination indicated by the one or more pieces of destination information;
an error information reception unit for receiving the information of error on the transmission of the E-mail or the error information having destination information;
an error information decision unit for deciding whether or not the error information received by the error information reception unit satisfies a predetermined condition;
a destination excluding unit for excluding the destination indicated by the destination information owned by the error information, from the candidates of the destination of the E-mail, in case the error information decision unit decides the satisfaction of the predetermined condition; and
a re-transmission decision unit for deciding whether or not a predetermined condition is satisfied, after the destination excluding unit performed the exclusion,
wherein the E-mail transmission unit transmits the E-mail to the excluded destination in case the re-transmission decision unit decides the satisfaction of the predetermined condition.

2. An E-mail transmission control device according to claim 1,
wherein the E-mail transmission unit transmits the E-mail not only to the excluded destination but also to the unexcluded destination, in case the re-transmission decision unit decides the satisfaction of the predetermined condition after the destination excluding unit executed the exclusion.

3. An E-mail transmission control device according to claim 1 or 2, further comprising:
an untransmitted E-Mail information configuring/holding unit for configuring the untransmitted E-mail information on the information of the E-mail which could not be and/or was not transmitted in a manner to correspond to the destination information, and for holding the untransmitted E-mail information;
a re-error information reception decision unit for deciding whether or not the error information has been received from the excluded destination, in case the re-transmission decision unit has decided the satisfaction of the predetermined condition after the destination excluding unit executed the exclusion so that the E-mail transmission unit has transmitted the E-mail to the excluded destination; and
an E-mail acquisition unit for deciding the E-mail, that is made to correspond to the destination information indicating the destination from which the error information has not been transmitted and that could not be and/or was not transmitted, from the untransmitted E-mail information held by the untransmitted E-mail information configuring/holding unit, in case the re-error information reception decision unit has decided that the error information was not received, and for acquiring the E-mail from the E-mail stored in the mail information storage unit,
wherein the E-mail transmission unit transmits the E-mail acquired by the E-mail acquisition unit, to the destination from which the error information has not been transmitted.

4. An E-mail transmission control device according to claim 3, further comprising:
a transmission propriety mail transmission unit for transmitting a transmission propriety mail or an E-mail inquiring the propriety of the transmission of the untransmitted mail to the destination, in case the re-error information reception decision unit has decided that the error information was not received; and
a reply acceptance unit for accepting a reply corresponding to the transmission propriety mail transmitted by the transmission propriety mail transmission unit,
wherein the E-mail acquisition unit decides the E-mail, that is made to correspond to the destination information indicating the destination from which the error information has not been transmitted and that could not be and/or was not transmitted, from the untransmitted E-mail information held by the untransmitted E-mail information configuring/holding unit, in case the reply acceptance unit accepts a reply and in case the reply indicates a transmittability, and acquires the E-mail from the E-mail stored in the mail information storage unit.

5. An E-mail transmission control device according to claim 1, further comprising:
an untransmitted E-Mail information configuring/holding unit for configuring the untransmitted E-mail information on the information of the E-mail which could not be and/or was not transmitted in a manner to correspond to the destination information, and for holding the untransmitted E-mail information;
a re-error information reception decision unit for deciding whether or not the error information has been received from the excluded destination, in case the re-transmission decision unit has decided the satisfaction of the predetermined condition after the destination excluding unit executed the exclusion so that the E-mail transmission unit has transmitted the E-mail to the excluded destination;
a menu information configuration unit for deciding the E-mail, that is made to correspond to the destination information indicating the destination, from which the error information has not been transmitted, and that could not be and/or was not transmitted to the destination, from the untransmitted E-mail information held by the untransmitted E-mail information configuring/holding unit, in case the re-error information reception decision unit has decided that the error information was not received, and for configuring menu information containing, as a menu item, E-mail specifying information to specify the E-mail from the information for discriminating the E-mail;
a menu information storage unit for storing the menu information configured by the menu information configuration unit;
an E-mail configuration unit for configuring an E-mail containing place specifying information or the information for specifying the existential place of the menu information stored by the menu information storage unit;
a menu information transmission unit for accepting an access to the place specifying information and for transmitting the menu information to the destination;
a menu item selecting information reception unit for receiving menu item selecting information or the information for selecting the menu item in response to the transmission of the menu information of the menu information transmission unit; and
an E-mail acquisition unit for acquiring the E-mail which is specified with the menu item indicated by the menu item selecting information received by the menu item selecting information reception unit, from the E-mail stored in the mail information storage unit,
wherein the E-mail transmission unit transmits the E-mail configured by the E-mail configuration unit, to the destination, and transmits the E-mail acquired by the E-mail acquisition unit, to the destination from which which the error information has not been transmitted.

6. An E-mail transmission control device according to claim 1, further comprising:
an untransmitted E-Mail information configuring/holding unit for configuring the untransmitted E-mail information on the information of the E-mail which could not be and/or was not transmitted in a manner to correspond to the destination information, and for holding the untransmitted E-mail information;
a re-error information reception decision unit for deciding whether or not the error information has been received from the excluded destination, in case the re-transmission decision unit has decided the satisfaction of the predetermined condition after the destination excluding unit executed the exclusion so that the E-mail transmission unit has transmitted the E-mail to the excluded destination;
a menu information configuration unit for deciding the E-mail, that is made to correspond to the destination information indicating the destination, from which the error information has not been transmitted, and that could not be and/or was not transmitted to the destination, from the untransmitted E-mail information held by the untransmitted E-mail information configuring/holding unit, in case the re-error information reception decision unit has decided that the error information was not received, and for configuring menu information containing, as a menu item, E-mail specifying information to specify the E-mail from the information for discriminating the E-mail;
a menu information storage unit for storing the menu information configured by the menu information configuration unit;
an E-mail configuration unit for configuring an E-mail containing place specifying information or the information for specifying the existential place of the menu information stored by the menu information storage unit;
a menu item selecting information reception unit for receiving selected menu item selecting information from the menu item owned by the menu information; and
an E-mail acquisition unit for acquiring the E-mail which is specified with the menu item indicated by the menu item selecting information received by the menu item selecting information reception unit, from the E-mail stored in the mail information storage unit,
wherein the E-mail transmission unit transmits the E-mail configured by the E-mail configuration unit, to the destination, and transmits the E-mail acquired by the E-mail acquisition unit, to the destination from which the error information has not been transmitted.

7. An E-mail transmission control device according to claim 1, further comprising:
an untransmitted E-Mail information configuring/holding unit for configuring the untransmitted E-mail information on the information of the E-mail which could not be and/or was not transmitted in a manner to correspond to the destination information, and for holding the untransmitted E-mail information;
a re-error information reception decision unit for deciding whether or not the error information has been received from the excluded destination, in case the re-transmission decision unit has decided the satisfaction of the predetermined condition after the destination excluding unit executed the exclusion so that the E-mail transmission unit has transmitted the E-mail to the excluded destination;
an E-mail information configuration unit for deciding the E-mail, that is made to correspond to the destination information indicating the destination from which the error information has not been transmitted and that could not be and/or was not transmitted, from the untransmitted E-mail information held by the untransmitted E-mail information configuring/holding unit, in case the re-error information reception decision unit has decided that the error information was not received, and for configuring the E-mail information containing the E-mail;
an E-mail information storage unit for storing the E-mail information configured by the E-mail information configuration unit;
an E-mail configuration unit for configuring an E-mail containing place specifying information or the information for specifying the existential place of the E-mail information stored by the E-mail information storage unit; and
an E-mail information transmission unit for accepting an access to the place specifying information and for transmitting the E-mail information to the destination from which the error information has not been transmitted,
wherein the E-mail transmission unit transmits the E-mail configured by the E-mail configuration unit, to the destination from which the error information has not been transmitted.

8. An E-mail transmission control device according to claim 1 or 2, further comprising:
an untransmitted E-Mail configuring/holding unit for configuring the untransmitted E-mail information on the information of the E-mail which could not be and/or was not transmitted in a manner to correspond to the destination information, and for holding the untransmitted E-mail information;
a re-error information reception decision unit for deciding whether or not the error information has been received from the excluded destination, in case the re-transmission decision unit has decided the satisfaction of the predetermined condition after the destination excluding unit executed the exclusion so that the E-mail transmission unit has transmitted the E-mail to the excluded destination;
an E-mail information configuration unit for deciding the E-mail, that is made to correspond to the destination information indicating the destination from which the error information has not been transmitted and that could not be and/or was not transmitted, from the untransmitted E-mail information held by the untransmitted E-mail information configuring/holding unit, in case the re-error information reception decision unit has decided that the error information was not received, and for configuring the E-mail information containing the E-mail;
an E-mail information storage unit for storing the E-mail information configured by the E-mail information configuration unit; and
an E-mail configuration unit for configuring an E-mail containing place specifying information or the information for specifying the existential place of the E-mail information stored by the E-mail information storage unit,
wherein the E-mail transmission unit transmits the E-mail configured by the E-mail configuration unit, to the destination from which the error information has not been transmitted.

9. An E-mail transmission control device according to claim 1, further comprising:
a re-error information reception decision unit for deciding whether or not the error information has been received from the excluded destination, in case the re-transmission decision unit has decided the satisfaction of the predetermined condition after the destination excluding unit executed the exclusion so that the E-mail transmission unit has transmitted the E-mail to the excluded destination; and
a destination restoring unit for restoring the destination from which the error information has not been transmitted, to the destination of an ordinary E-mail, in case the re-error information reception decision unit has decided that the error information was not received.

10. An E-mail transmission control device according to claim 1,
wherein the predetermined condition is that a predetermined period has elapsed after the destination excluding unit executed the exception.

11. An E-mail transmission control device according to claim 1,
wherein the predetermined condition is that the E-mail transmission unit has transmitted the E-mail by predetermined times after the destination excluding unit executed the exclusion.

12. An E-mail transmission control device,
wherein an E-mail is transmitted to a destination that has been once excluded from the candidates of the destination to which the E-mail is to be transmitted, in case a predetermined condition is satisfied.

13. A program for causing a computer to execute:
an E-mail transmission step of transmitting an E-mail to the destination indicated by the one or more pieces of destination information;
an error information reception step of receiving the information of error on the transmission of the E-mail or the error information having destination information;
an error information decision step of deciding whether or not the error information received by the error information reception step satisfies a predetermined condition;
a destination excluding step of excluding the destination indicated by the destination information owned by the error information, from the candidates of the destination of the E-mail, in case the error information decision step decides the satisfaction of the predetermined condition;
a re-transmission decision step of deciding whether or not a predetermined condition is satisfied, after the destination excluding step performed the exclusion; and
an E-mail transmission step of transmitting the E-mail to the excluded destination in case the re-transmission decision step decides the satisfaction of the predetermined condition.

14. A program for causing a computer to further execute:
a transmission step of transmitting the E-mail not only to the excluded destination but also to the unexcluded destination, in case the satisfaction of the predetermined condition is decided at the re-transmission deciding step, after the destination excluding unit executed the exclusion.

15. A program for causing a computer to further execute:
an untransmitted E-Mail information configuring/holding step of holding the untransmitted E-mail information on the information of the E-mail which could not be and/or was not transmitted in a manner to correspond to the destination information;
a re-error information reception decision step of deciding whether or not the error information has been received from the excluded destination, in case the re-transmission decision step has decided the satisfaction of the predetermined condition after the destination excluding step executed the exclusion so that the E-mail has been transmitted to the excluded destination;
an E-mail acquisition step of deciding the E-mail, that is made to correspond to the destination information indicating the destination from which the error information has not been transmitted and that could not be and/or was not transmitted, from the untransmitted E-mail information held at the untransmitted E-mail information configuring/holding step, in case it has been decided at the re-error information reception decision step that the error information was not received, and acquiring the E-mail from the E-mail stored at the mail information storage step; and
a transmission step of transmitting the E-mail acquired at the E-mail acquisition step, to the destination from which the error information has not been transmitted.

16. A program for causing a computer to further execute:
a transmission propriety mail transmission step of transmitting a transmission propriety mail or an E-mail inquiring the propriety of the transmission of the untransmitted mail to the destination, in case it has been decided at the re-error information reception decision step that the error information was not received;
a reply acceptance step of accepting a reply corresponding to the transmission propriety mail transmitted at the transmission propriety mail transmission step; and
an acquisition step of deciding and acquiring the E-mail, that is made to correspond to the destination information indicating the destination from which the error information has not been transmitted and that could not be and/or was not transmitted, from the untransmitted E-mail information held at the untransmitted E-mail information configuring/holding step, in case the reply is accepted at the reply acceptance step and in case the reply indicates a transmittability.

17. A program for causing a computer to further execute:
an untransmitted E-Mail information configuring/holding step of holding the untransmitted E-mail information on the information of the E-mail which could not be and/or was not transmitted in a manner to correspond to the destination information;
a re-error information reception decision step of deciding whether or not the error information has been received from the excluded destination, in case the re-transmission decision step has decided the satisfaction of the predetermined condition after the destination excluding step executed the exclusion so that the E-mail has been transmitted to the excluded destination;
a menu information configuration step of deciding the E-mail, that is made to correspond to the destination information indicating the destination, from which the error information has not been transmitted, and that could not be and/or was not transmitted to the destination, from the untransmitted E-mail information held at the untransmitted E-mail information configuring/holding step, in case it has been decided at the re-error information reception decision step that the error information was not received, and configuring menu information containing, as a menu item, E-mail specifying information to specify the E-mail from the information for discriminating the E-mail;
a menu information storage step of storing the menu information configured at the menu information configuration step;
an E-mail configuration step of configuring an E-mail containing place specifying information or the information for specifying the existential place of the menu information stored at the menu information storage step;
a menu information transmission step of transmitting the E-mail configured at the E-mail configuration step to the destination, and accepting an access to the place specifying information and for transmitting the menu information to the destination;
a menu item selecting information reception step of receiving menu item selecting information or the information for selecting the menu item in response to the transmission of the menu information of the menu information transmission step;
an E-mail acquisition step of acquiring the E-mail which is specified with the menu item indicated by the menu item selecting information received at the menu item selecting information reception step; and
a transmission step of transmitting the E-mail acquired at the E-mail acquisition step, to the destination from which the error information has not been transmitted.

18. A program for causing a computer to further execute:
an untransmitted E-Mail information configuring/holding step of holding the untransmitted E-mail information on the information of the E-mail which could not be and/or was not transmitted in a manner to correspond to the destination information;
a re-error information reception decision step of deciding whether or not the error information has been received from the excluded destination, in case the re-transmission decision step has decided the satisfaction of the predetermined condition after the exclusion was executed at the destination excluding step so that the E-mail has been transmitted to the excluded destination;
a menu information configuration step of deciding the E-mail, that is made to correspond to the destination information indicating the destination, from which the error information has not been transmitted, and that could not be and/or was not transmitted to the destination, from the untransmitted E-mail information held by the untransmitted E-mail information configuring/holding step, in case it has been decided at the re-error information reception decision step that the error information was not received, and configuring menu information containing, as a menu item, E-mail specifying information to specify the E-mail from the information for discriminating the E-mail;
a menu information storage step of storing the menu information configured at the menu information configuration step;
an E-mail configuration step of configuring an E-mail containing place specifying information or the information for specifying the existential place of the menu information stored at the menu information storage step;
a menu item selecting information reception step of transmitting the E-mail configured at the E-mail configuration step to the destination and receiving selected menu item selecting information from the menu item owned by the menu information;
an E-mail acquisition step of acquiring the E-mail which is specified with the menu item indicated by the menu item selecting information received at the menu item selecting information reception step; and
a transmission step of transmitting the E-mail acquired at the E-mail acquisition step, to the destination from which the error information has not been transmitted.

19. A program for causing a computer to further execute:
an untransmitted E-Mail information configuring/holding step of holding the untransmitted E-mail information on the information of the E-mail which could not be and/or was not transmitted in a manner to correspond to the destination information;
a re-error information reception decision step of deciding whether or not the error information has been received from the excluded destination, in case the re-transmission decision step has decided the satisfaction of the predetermined condition after the exclusion was executed at the destination excluding step so that the E-mail has been transmitted to the excluded destination;
an E-mail information configuration step of deciding the E-mail, that is made to correspond to the destination information indicating the destination from which the error information has not been transmitted and that could not be and/or was not transmitted, from the untransmitted E-mail information held at the untransmitted E-mail information configuring/holding step, in case it has been decided at the re-error information reception decision step that the error information was not received, and configuring the E-mail information containing the E-mail;
an E-mail information storage step of storing the E-mail information configured at the E-mail information configuration step;
an E-mail configuration step of configuring an E-mail containing place specifying information or the information for specifying the existential place of the E-mail information stored at the E-mail information storage step;
a transmission step of transmitting the E-mail configured at the E-mail configuration step, to the destination from which the error information has not been transmitted and
an E-mail information transmission step of accepting an access to the place specifying information and transmitting the E-mail information to the destination from which the error information has not been transmitted.

20. A program for causing a computer to further execute:
an untransmitted E-Mail information configuring/holding step of holding configuring the untransmitted E-mail information on the information of the E-mail which could not be and/or was not transmitted in a manner to correspond to the destination information;
a re-error information reception decision step of deciding whether or not the error information has been received from the excluded destination, in case the re-transmission decision step has decided the satisfaction of the predetermined condition after the exclusion was executed at the destination excluding step so that the E-mail has been transmitted to the excluded destination;
an E-mail information configuration step of deciding the E-mail, that is made to correspond to the destination information indicating the destination from which the error information has not been transmitted and that could not be and/or was not transmitted, from the untransmitted E-mail information held at the untransmitted E-mail information configuring/holding step, in case it has been decided at the re-error information reception decision step that the error information was not received, and for configuring the E-mail information containing the E-mail;
an E-mail information storage step of storing the E-mail information configured at the E-mail information configuration step;
an E-mail configuration step of configuring an E-mail containing place specifying information or the information for specifying the existential place of the E-mail information stored at the E-mail information storage step; and
a transmission step of transmitting the E-mail configured at the E-mail configuration step, to the destination from which the error information has not been transmitted.

21. A program for causing a computer to further execute:
a re-error information reception decision step of deciding whether or not the error information has been received from the excluded destination, in case the re-transmission decision step has decided the satisfaction of the predetermined condition after the exclusion was executed at the destination excluding step so that the E-mail has been transmitted to the excluded destination; and
a destination restoring step of restoring the destination from which the error information has not been transmitted, to the destination of an ordinary E-mail, in case it has been decided at the re-error information reception decision step that the error information was not received.

22. A computer readable medium including a program according to claim 13.
